(19) United States
(12) Patent Application Publication
(10) Pub. No.: US 2008/0016528 A1
(43) Pub. Date: Jan. 17, 2008

(54) INFORMATION-PROCESSING DEVICE, INFORMATION-PROCESSING METHOD, AND COMPUTER PROGRAM

(75) Inventor: Satoshi YOSHINAGA, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 11/767,788

(22) Filed: Jun. 25, 2007

(30) Foreign Application Priority Data
Jul. 12, 2006 (JP) 2006-191115

(51) Int. Cl. G06F 3/00

(52) U.S. Cl. 725/39

(57) ABSTRACT

An information-processing device transferring data via at least one cable is provided. The information-processing device includes a display unit configured to perform information-display processing, and a control unit configured to display guide information used for performing cable-connection processing on the display unit. When the guide information is displayed, the control unit displays terminal-image data on the display unit, the terminal-image data indicating a shape of each of a plurality of terminals to which the at least one cable is connected, and displays cable-image data on the display unit based on terminal-selection information input by a user, the cable-image data indicating the cable shape corresponding to a cable ready for a selected terminal.

### CROSS REFERENCES TO RELATED APPLICATIONS

The present invention contains subject matter related to Japanese Patent Application JP 2006-191115 filed in the Japanese Patent Office on Jul. 12, 2006, the entire contents of which are incorporated herein by reference.

### BACKGROUND OF THE INVENTION

1. Field of the Invention

The present invention relates to an information-processing device, an information-processing method, and a computer program, and particularly relates to an information-processing device, an information-processing method, and a computer program that are provided to guide a user establishing a cable connection and performing setting processing when data on an image picked up by a video camera or the like is output to a display device such as a television (TV).

2. Description of the Related Art

For example, data on an image picked up by the video camera is stored in a storage section provided in the video camera. The picked-up-image data can be reproduced not only by using a monitor attached to the video camera but also by connecting the video camera to an external TV by using a cable.

In recent years, there have been introduced video cameras that can photograph an image with high-definition (HD) quality higher than known standard-definition (SD) quality. Further, there have been introduced TVs that can reproduce HD images. Subsequently, the number of users of the TVs that can reproduce the HD images increases.

When an image photographed by a video camera is output to a TV and reproduced, the image photographed by the video camera may be an SD image and/or an HD image. Further, the TV to which the photographed image is output is either a TV that can reproduce the HD image or a TV that can reproduce the HD image with difficulty. Namely, a data-output-source device and a data-output-destination device may be used in combination in various ways.

Thus, as various devices have been introduced in these days, there have been introduced various types of cables used for inputting and/or outputting data. Therefore, a user of a device should select a cable ready for the device from among the various types of cables. Further, since sound data and image data should be transferred to perform data reproduction, the user should select an appropriate cable and establish a correct cable connection.

The user should select a cable ready for a terminal provided on the device, namely, the cable-connection terminal corresponding to the cable type, and connect the cable to the device. The cable-connection terminal includes, for example, a pin terminal and a D terminal that have been used for many devices. Further, the cable-connection terminal includes a high-definition-multimedia-interface (HDMI) terminal generated under the HDMI standard which allows for outputting an image signal and a sound signal in combination. Thus, since the various types of terminals are provided on video cameras and TVs, the user should select a cable ready for the terminal and establish a connection between the above-described devices. However, it is difficult for many ordinary users to perform the above-described cable selection and cable connection.

When the user establishes an erroneous connection, data may be transferred incorrectly. Further, even though the user's device is capable of reproducing a high-quality image, a low-quality image may be reproduced due to the erroneous connection.

### SUMMARY OF THE INVENTION

According to an embodiment of the present invention, there are provided an information-processing device, an information-processing method, and a computer program that are capable of guiding an ordinary user establishing a cable connection and/or performing setting processing in an understandable manner when data on an image photographed by a video camera or the like is output to a display device such as a TV, so that the ordinary user can easily establish a correct cable connection with certainty.

According to an embodiment of the present invention, there is provided an information-processing device transferring data via at least one cable. The information-processing device includes a display unit configured to perform information-display processing and a control unit configured to display guide information used for performing cable-connection processing on the display unit. When the guide information is displayed, the control unit displays terminal-image data on the display unit, the terminal-image data indicating a shape of each of a plurality of terminals to which the at least one cable is connected, and displays cable-image data on the display unit based on terminal-selection information input by a user, the cable-image data indicating the cable shape corresponding to a cable ready for a selected terminal.

Further, in the above-described information-processing device, the control unit displays external-device-terminal-image data on at least two external-device terminals that can be provided on an external device that is to be connected to the information-processing device by using the at least one cable on the display unit, and displays cable-image data on a cable ready for a selected external-device terminal based on information about the selected external-device terminal, the selected information being input by the user.

Further, in the above-described information-processing device, when the cable-image data is displayed, the control unit displays the cable-image data and the terminal-image data on the connection terminal corresponding to each of ends of the at least one cable in combination.

Further, in the above-described information-processing device, the control unit displays the terminal-image data on the plurality of terminals to which the at least one cable is connected and a description of processing performed by using the terminal corresponding to the displayed terminal-image data on the display unit.

Further, in the above-described information-processing device, the control unit displays reference information used for connecting the at least one cable on the display unit.

Further, in the above-described information-processing device, the control unit displays reference information used for connecting the at least one cable and information used for accepting shifting to a screen image showing setting processing performed in the information-processing device when the reference information includes a description of the setting processing on the display unit.

Further, in the above-described information-processing device, the control unit displays a confirmation-screen image of a type of a device to which the at least one cable is connected on the display unit, selects the guide information corresponding to a specified device based on information that is input by the user and that specifies the device type, and displays the selected guide information on the display unit.

Further, in the above-described information-processing device, when an image picked up by the information-processing device and/or an image stored in a storage unit is displayed on the display unit, the control unit superimposes the guide information on the displayed image, as a translucent image, so that the guide information is displayed.

Further, according to another embodiment of the present invention, there is provided an information-processing method used for displaying guide information used for establishing a cable connection in an information-processing device transferring data via at least one cable. The information-processing method includes the steps of displaying terminal-image data indicating a shape of each of a plurality of terminals to which the at least one cable is connected on a display unit by a control unit, detecting terminal-selection information by the control unit, the terminal-selection information being input by the user, and displaying cable-image data indicating the cable shape corresponding to a cable ready for a terminal selected by the user by the control unit.

Further, in the above-described information-processing method, the terminal-image-data-display step is a step of displaying external-device-terminal-image data on a plurality of external-device terminals that can be provided on an external device that is to be connected to the information-processing device by using the at least one cable on the display unit. The terminal-selection-information-detection step is a step of detecting that the user inputs information about selection of an external-device terminal and the cable-image-data-display step is a step of displaying the cable-image data on a cable ready for the external-device terminal selected by the user.

Further, in the above-described information-processing method, the cable-image-data-display step is a step of displaying the cable-image data and the terminal-image data on the connection terminal corresponding to each of ends of the at least one cable in combination when the cable-image data is displayed.

Further, in the above-described information-processing method, the terminal-image-data-display step is a step of displaying terminal-image data on the plurality of terminals to which the at least one cable is connected and a description of processing performed by using the terminal corresponding to the displayed terminal-image data on the display unit.

The above-described information-processing method further includes the step of displaying reference information used for connecting the at least one cable on the display unit by using the control unit.

Further, in the above-described information-processing method, the reference-information-display step is a step of displaying reference information used for connecting the at least one cable and information used for accepting shifting to a screen image showing setting processing performed in the information-processing device when the reference information includes a description of the setting processing on the display unit.

The above-described information-processing method further includes the step of displaying a confirmation-screen image of a type of a device to which the at least one cable is connected on the display unit, selecting the guide information corresponding to a specified device based on information that is input by the user and that specifies the device type, and displaying the selected guide information on the display unit by the control unit.

The above-described information-processing method further includes the step of displaying the guide information when an image picked up by the information-processing device and/or an image stored in a storage unit is displayed on the display unit under the control of the control unit by superimposing the guide information on the displayed image, as a translucent image.

Further, according to another embodiment of the present invention, there is provided a computer program which makes an information-processing device display guide information used for establishing a cable connection, the information-processing device transferring data by using at least one cable. The computer program includes the steps of displaying terminal-image data indicating a shape of each of a plurality of terminals to which the at least one cable is connected on a display unit by a control unit, detecting terminal-selection information by the control unit, the terminal-selection information being input by the user, and displaying cable-image data indicating the cable shape corresponding to a cable ready for a terminal selected by the user by the control unit.

Further, a computer program according to an embodiment of the present invention can be supplied to a general-purpose computer system that can execute various program codes through a computer-readable storage medium, a communication medium, a storage medium including a compact disk (CD), a flexible disk (FD), a magneto-optical (MO) disk, and so forth, or a communication medium such as a network. By supplying the above-described program in a computer-readable manner, the processing corresponding to the program is executed on the computer system.

Other characteristics and/or advantages of the present invention will be clearly described in detail with reference to the embodiments thereof and the attached drawings. The term “system” used in this specification denotes a logical set of at least two devices and the devices may not be provided in the same cabinet.

According to another embodiment of the present invention, when guide information relating to cable-connection processing is displayed, terminal-image data indicating a shape of each of a plurality of terminals to which cables are connected is displayed, and cable-image data indicating the cable shape corresponding to a cable ready for a selected terminal is displayed based on terminal-selection information input by a user. Therefore, the user can select a correct cable and establish a correct connection with certainty.

Further, an information-processing device according to another embodiment of the present invention displays guide-screen images in sequence, the guide-screen images including:

(A) Selection-screen image provided to select the type of a cable-connection device (e.g., a TV),

(B) Selection-screen image including image data on the shape of each of terminals provided on the cable-connection device,

(C) Cable-confirmation-screen image showing the correspondence between image data on the cable corresponding to the terminal and a connection terminal, and

(D) Hint (reference information)-screen image.

Therefore, the user selects the type of the cable-connection device such as the TV and the shape of each of the terminals, and performs processing according to information shown on the guide-screen image. Subsequently, the user can perform the cable connection with facility and stability.

### BRIEF DESCRIPTION OF THE DRAWINGS

FIG. 1 illustrates an example configuration of a TV connected to an image-pickup device provided, as an information-processing device according to an embodiment of the present invention, by using a cable, and example cable-connection processing;

FIG. 2 illustrates an example configuration of a TV-connection-guide-initial-screen image displayed on a display unit of the above-described information-processing device;

FIG. 3 illustrates an example configuration of each of terminal-selection-screen images displayed on the display unit of the above-described information-processing device;

FIG. 4 illustrates an example configuration of each of cable-confirmation-screen images displayed on the display unit of the above-described information-processing device;

FIG. 5 illustrates an example configuration of each of cable-connection-hint-screen images displayed on the display unit of the above-described information-processing device;

FIG. 6 illustrates an example configuration of a component-output-setting-screen image displayed on the display unit of the above-described information-processing device;

FIG. 7 illustrates an example configuration of each of connection-completion-confirmation-screen images displayed on the display unit of the above-described information-processing device;

FIG. 8 illustrates an example configuration of each of other terminal-selection-screen images displayed on the display unit of the above-described information-processing device;

FIG. 9 illustrates an example configuration of each of other cable-confirmation-screen images displayed on the display unit of the above-described information-processing device;

FIG. 10 illustrates an example configuration of each of other cable-connection-hint-screen images displayed on the display unit of the above-described information-processing device;

FIG. 11 illustrates an example configuration of each of device-setting-screen images displayed on the display unit of the above-described information-processing device;

FIG. 12 is a flowchart illustrating a cable-connection-guide-processing sequence performed by the above-described information-processing device;

FIG. 13 shows flowcharts, where each of the flowcharts illustrates another cable-connection-guide-processing sequence performed by the above-described information-processing device;

FIG. 14 shows flowcharts, where each of the flowcharts illustrates another cable-connection-guide-processing sequence performed by the above-described information-processing device;

FIG. 15 shows a flowchart illustrating another cable-connection-guide-processing sequence performed by the above-described information-processing device;

FIG. 16 is a block diagram illustrating the functional configuration of an information-processing device according to another embodiment of the present invention; and

FIG. 17 illustrates an example hardware configuration of an image-pickup device relating to an information-processing device according to another embodiment of the present invention.

### DESCRIPTION OF THE PREFERRED EMBODIMENTS

Hereinafter, an information-processing device, an information-processing method, and a computer program according to an embodiment of the present invention will be described in detail with reference to the attached drawings.

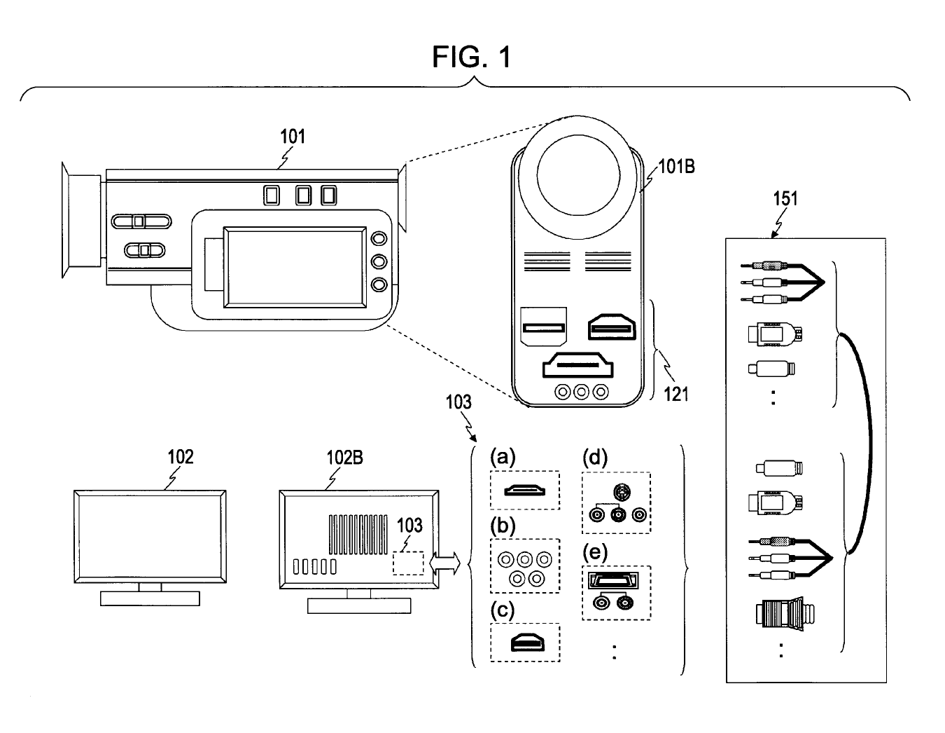

First, connection processing is performed for an image-pickup device 101 including a video camera by using a cable, for example, where the image-pickup device 101 is provided, as the information-processing device according to the above-described embodiment. FIG. 1 shows the image-pickup device 101 including the video camera and a television (TV) 102. Data on an image picked up by the image-pickup device 101 is stored in storage media of the image-pickup device 101, the storage media including a hard disk, a digital-versatile disk (DVD), a flash memory, and so forth. The data stored in the above-described storage media can be output to the TV 102 and reproduced by performing the cable connection.

FIG. 1 shows an image-pickup-device-rear face 101B, as one of faces of the image-pickup device 101. At least two different types of terminals 121 to which at least two different types of cables can be connected are provided on the image-pickup-device-rear face 101B. The cables correspond to the types of apparatuses including a TV or the like to which data is output.

On the other hand, one of terminals 103(a), 103(b), 103(c), 103(d), and 103(e) shown in FIG. 1, for example, is provided on a TV-rear face 102B, which is one of the faces of the TV 102, according to the TV type, for example. Subsequently, data can be input to the TV 102 through the cable.

At least two types of cables 151 used for transferring sound data and image data are provided, where the types of the cables 151 correspond to those of the terminals. When a user wishes to output data from the image-pickup device to a data-output apparatus such as a TV, the user selects a cable appropriate for a terminal provided on the data-output apparatus and makes necessary settings on the data-output apparatus.

Hitherto, various types of terminals used for inputting and outputting data have been introduced. Such terminals include, for example, a pin terminal, a D terminal, a high-definition-multimedia-interface (HDMI) terminal developed under the HDMI standard, and so forth that have been used for many devices and/or apparatuses. The HDMI terminal is used so that an image signal and a sound signal can be output simultaneously through a single cable. The above-described different terminals are provided on a data-input-and-output apparatus including a video camera, a TV, and so forth. Therefore, the user should select a cable appropriate for a terminal and establishes the connection between the data-input-and-output device and the image-pickup device 101.

The above-described cable selection and connection processing are not easy for many ordinary users to perform. Therefore, the information-processing device according to the above-described embodiment guides the ordinary user through cable connection and/or setting processing so that the user can establish a correct cable connection with confidence and facility. Subsequently, data can be transferred and reproduced correctly. Hereinafter, a video camera will be described, for example, as an information-processing device outputting data. However, according to another embodiment of the present invention, not only the video camera, but also any apparatus configured to input and/or output data via a cable can be used, as the above-described information-processing device. Namely, the above-described information-processing device includes all apparatuses configured to input and output data, the apparatuses including an apparatus configured to reproduce data recorded onto a videotape and/or a DVD, for example.

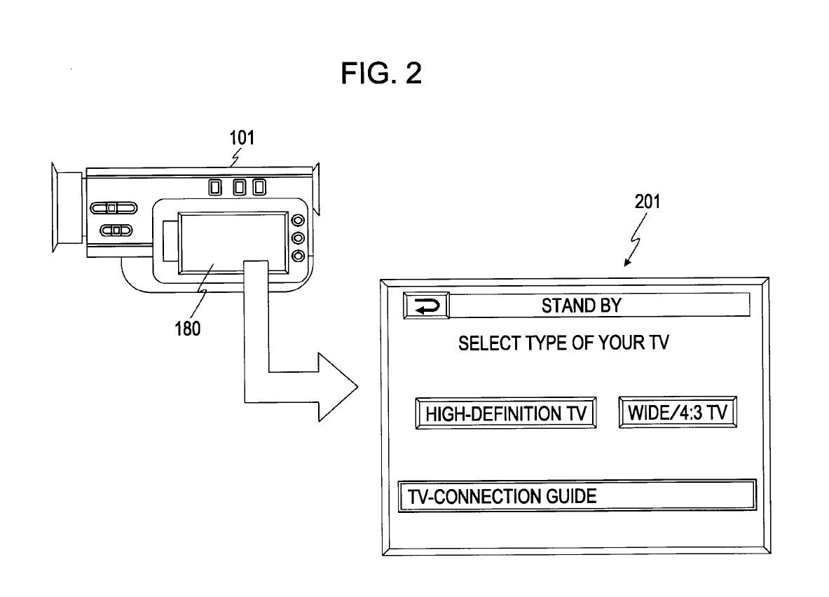

A cable-connection-guide function performed by the above-described information-processing device will be described in detail with reference to FIG. 2 and drawings thereafter.

FIG. 2 shows a TV-connection-guide-initial-screen image 201 shown on a display unit 180 of the above-described information-processing device provided, as the image-pickup device 101. The display unit 180 is configured, as a liquid-crystal monitor or the like on which a picked-up image and/or a reproduction image is displayed. The display unit 180 can be used to display images of guides and/or manuals of various types. First, the user displays a menu-screen image on the display unit 180, and selects a menu item [TV-connection guide] set on the menu-screen image. Subsequently, the TV-connection-guide-initial-screen image 201 shown in FIG. 2 is displayed.

Here, each of the various types of guides displayed on the display unit 180 may be switched from the picked-up image and/or the reproduction image displayed on the display unit 180. Otherwise, each of the various types of guides may be shown with the picked-up image and/or the reproduction image. If the guide is to be shown with the picked-up image and/or the reproduction image, the screen image shown on the display unit 180 can be divided into at least two parts so that the guide and the picked-up image and/or the reproduction image can be displayed in parallel. Otherwise, information about the guide can be superimposed on the picked-up image and/or the reproduction image and displayed, as translucent image data.

Further, a TV-connection guide that will be described later is displayed under the control of a control unit provided in the information-processing device provided, as the image-pickup device 101 according to a program stored in a storage unit provided in the information processing device 101.

The TV-connection-guide-initial-screen image 201 shown in FIG. 2 is provided for the user performing the cable connection, so as to make the user input information about the type of a TV which is to be connected to the information-processing device 101. The TV-connection-guide-initial-screen image 201 shown in FIG. 2 is used by the user, so as to input information about under which of two categories the TV for connection falls. The two categories include:

[high-definition TV], and

[wide and/or 4:3 TV].

When the above-described question is raised by the TV-connection-guide-initial-screen image 201, the user confirms the type of the TV for connection and inputs information about the TV type by performing an operation or touching the display unit 180 including a touch panel, or operating at least one operation button of the information-processing device 101. When the control unit of the information-processing device 101 detects the information input by the user, the control unit selects the next guide-screen image corresponding to the information input by the user and displays the next guide-screen image on the display unit 180.

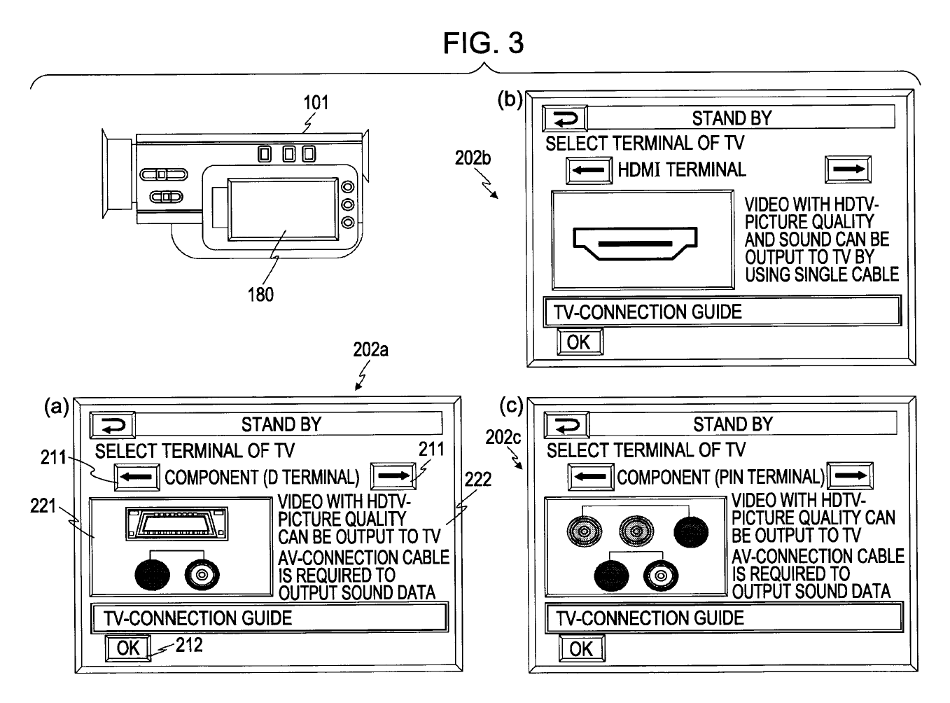

According to FIG. 2, the user selects either the category [high-definition TV] or the category [wide and/or 4:3 TV]. First, example guide processing performed when the user selects the category [high-definition TV] will be described with reference to FIG. 3 and drawings thereafter.

When the user performs an operation, so as to select the category [high-definition TV] on the TV-connection-guide-initial-screen image 201 shown in FIG. 2, the control unit of the information-processing device 101 detects the operation information and performs the display-information switching. Namely, terminal-selection screen images 202a, 202b, and 202c shown in FIG. 3 are displayed on the display unit 180. By operating an image-switch icon 211 shown on each of the three types of terminal-selection-screen images 202a to 202c, it becomes possible to switch between the terminal-selection-screen images 202a to 202c in sequence.

Each of the terminal-selection-screen images 202a to 202c shown in FIG. 3 allows the user to confirm the type of a terminal provided on a device for connection such as a TV connected to the information-processing device 101 via the cable.

Each of the terminal-selection-screen images 202a to 202c includes image data 221 on the terminal of the device for connection and data 222 on the description of each of the terminals for use. FIG. 3 shows three types of terminals including:

(a) component (D terminal),

(b) HDMI terminal, and

(c) component (pin terminal).

It becomes possible to switch between the three types of terminal-selection-screen images 202a to 202c for display, the terminal-selection-screen images 202a to 202c corresponding to the above-described three types of terminals. Thus, according to the above-described embodiment, the three types of terminal-selection-screen images 202a to 202c are switched from one another so that each of the terminal-selection-screen images 202a to 202c is displayed separately. However, all of the three types of terminal-selection-screen images 202a to 202c may be aligned and displayed.

The terminal-image data 221 of the device for connection is data on an image of the terminal provided on the TV which is the device for connection. Therefore, the user can confirm the shape of the terminal of the TV and select a terminal of which shape agrees with that of the terminal of the TV based on the image data shown in the terminal-selection-screen images 202a to 202c. Here, if at least two types of terminals are provided on the TV functioning, as the device for connection, the user can select either of the two types of terminals. For example, the user can select an appropriate terminal with reference to the description data 222.

For example, data on the description of

(a) Component (D terminal)

is written, as “Video with HDTV-picture quality can be output to TV. An AV-connection cable is used to output sound data”, and data on the description of

(b) HDMI terminal

is written, as “Video with HDTV-picture quality and sound data can be output to TV by using single cable”. Data on the description of

(c) Component (pin terminal)

is written, as “Video with HDTV-picture quality can be output to TV. An AV-connection cable is used to output sound data”. Each of the above-described description data includes information about the characteristics, advantage, and cautions in outputting data through the connection achieved by using each of the terminals. Subsequently, the user can select an appropriate cable terminal based on the above-described descriptions.

The user inputs selection information by operating an OK icon 212, so as to select a single terminal from among terminals shown on the terminal-selection-screen images 202a to 202c shown in FIG. 3, as the connection terminal. The user inputs the selection information by performing an operation for display unit 180, or touching the display unit 180 configured, as a touch panel. When the control unit of the information-processing device 101 detects the information input by the user, the control unit selects the next guide-screen image corresponding to the information input by the user and displays the guide-screen image on the display unit 180.

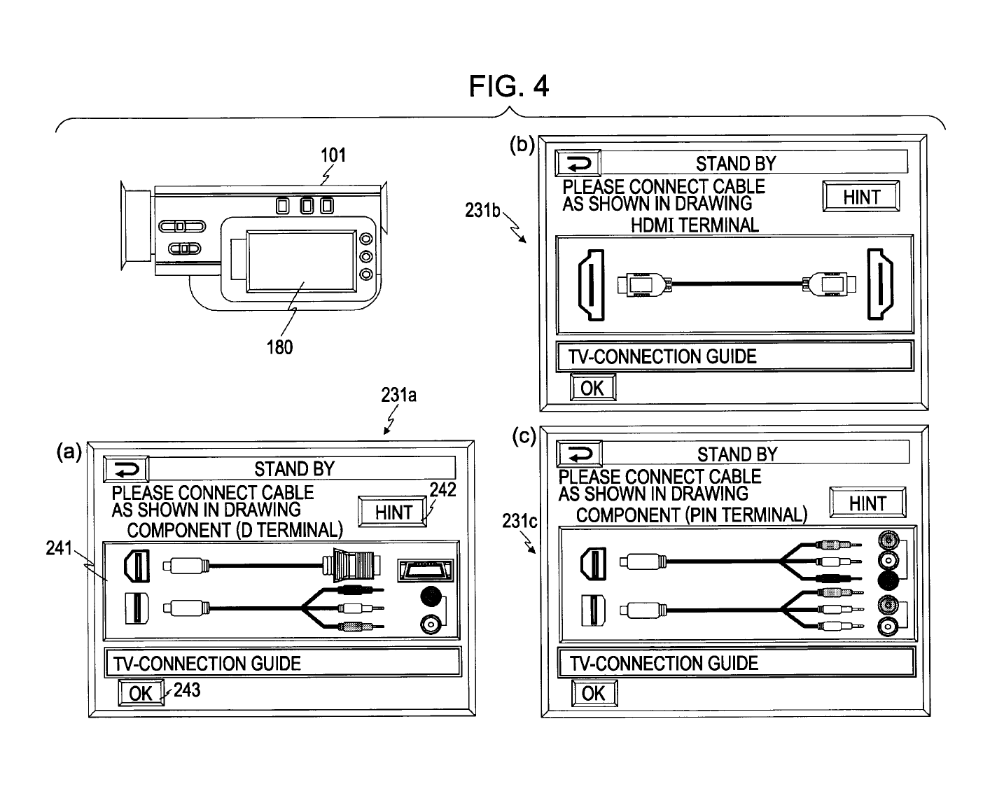

FIG. 4 shows example display-screen images obtained when the OK icon 212 is operated on the three terminal-selection-screen images 202a to 202c shown in FIG. 3, the terminal-selection-screen images 202a to 202c showing

(a) Component (D terminal)

(b) HDMI terminal, and

(c) Component (pin terminal).

FIG. 4 shows the cable-confirmation-screen images 231a, 231b, and 231c corresponding to the three terminal-selection-screen images 202a, 202b, and 202c shown in FIG. 3. Each of the three types of cable-confirmation-screen images 231a to 231c shown in FIG. 4 is a screen image shown on the display unit 180 when one of the above-described three types of terminals including:

(a) component (D terminal),

(b) HDMI terminal, and

(c) component (pin terminal)

is selected, namely, when the OK icon 212 shown in one of the terminal-selection-screen images 202a to 202c shown in FIG. 3 is operated. Subsequently, the user can confirm the cable corresponding to the selected terminal by viewing each of the cable-confirmation-screen images 231a to 231c.

The cable-confirmation-screen images 231a to 231c shown in FIG. 4 are provided so that the user can confirm a cable that can be used for connecting the information-processing device 101, which is a data-output-source device, to a data-output-destination device which is the TV according to the above-described embodiment.

Each of the cable-confirmation-screen images 231a to 231c includes cable-connection-image data 241 showing at least one cable appropriate for connection, and the correspondence between the at least one appropriate cable and terminals of devices that are to be connected to both ends of the appropriate cable. The cable-connection-image data 241 includes not only the image data on the at least one cable but also image data on the terminals of devices that are to be connected to the cable. Image data on at least one terminal of each of two devices connected to each other via the cable, namely, terminals of the information-processing device or the image-pickup device functioning, as the data-output-source device, and the data-output-destination device which is the TV in the above-described embodiment are displayed so that the correspondence between the above-described terminals and connection ends of the cable is displayed. The user can select the cable displayed, as the cable-connection-image data 241, and confirm the shape of each of the terminals of the TV and/or the image-pickup device, where the terminals are shown, as the cable-connection-image data 241. Subsequently, the user can perform the cable connection correctly by selecting at least one appropriate cable and determining the connection orientation with certainty.

Further, as shown in FIG. 4, a hint-call icon 242 is provided on each of the cable-confirmation-screen images 231a to 231c, where the term “hint” denotes reference information. When the user operates the hint-call icon 242, a hint-screen image showing information about the cable connection is presented. Namely, when the control unit of the information-processing device 101 detects information about the operation performed by the user for the hint-call icon 242, the control unit displays the hint-screen image on the display unit 180.

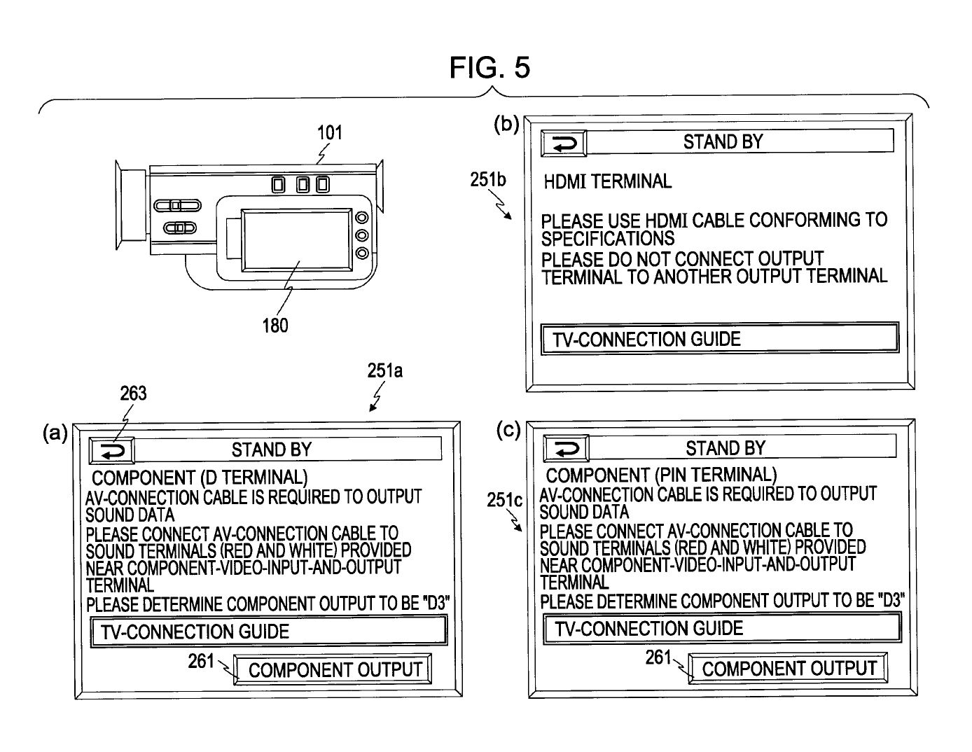

Parts (a), (b), and (c) of FIG. 5 show the cable-connection-hint-screen images 251a, 251b, and 251c corresponding to the three types of cable-confirmation-screen images 231a, 231b, and 231c shown in FIG. 4, for example. The cable-connection-hint-screen images 251a to 251c shown in FIG. 5 correspond to the terminal-selection-screen images 202a to 202c shown in FIG. 3 and the cable-confirmation-screen images 231a to 231c. Further, the cable-connection-hint-screen images 251a to 251c correspond to the cable-connection methods achieved by using the three types of terminals including:

(a) Component (D terminal),

(b) HDMI terminal, and

(c) Component (pin terminal).

Part (a) of FIG. 5 shows hint information relating to the cable-connection method achieved by using the component (D terminal). More specifically, the hint information is read, as

“AV-connection cable is used to output sound data. Please connect AV-connection cable to sound terminals (red and white) provided near Component-video-input-and-output terminal. Please determine component output to be “D3”.

Further, Part (b) of FIG. 5 shows hint information relating to the cable-connection method achieved by using the HDMI terminal. More specifically, the hint information is read, as

“Please use HDMI cable conforming to specifications. Please do not connect output terminal to another output terminal”.

Further, Part (c) of FIG. 5 shows hint information relating to the cable-connection method achieved by using the component or the pin terminal. More specifically, the hint information is read, as

“AV-connection cable is used to output sound data. Please connect AV-connection cable to sound terminals (red and white) provided near Component-video-input-and-output terminal. Please determine component output to be “D3””.

The above-described hint information is presented, as the hint information corresponding to each of the terminals and/or the cables.

Thus, each of the cable-connection-hint-screen images 251a to 251c is provided with hint information including information about a detailed description, cautions, settings, and so forth required to achieve the cable connection. If settings are to be made to achieve the cable connection, an icon is displayed on each of the cable-connection-hint-screen images 251a to 251c, the icon being used for shifting to a setting-screen image. More specifically, a component-output icon 261 is shown in each of parts (a) and (c) of FIG. 5.

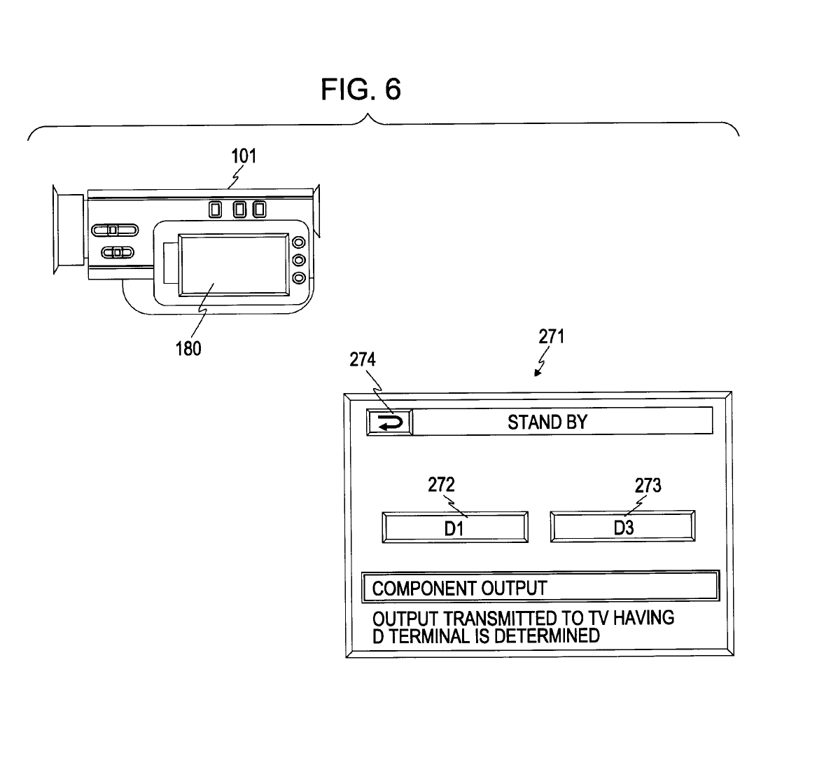

When the user operates the above-described component-output icons 261, the control unit detects information about the above-described operation and shifts from the currently displayed screen image to a device-setting-processing-screen image used to achieve the cable connection. FIG. 6 shows an example of the above-described device-setting-processing-screen image displayed after the shifting. Namely, FIG. 6 shows a component-output-setting-screen image 271, as one of device-setting-screen images displayed on the display unit 180.

The component-output-setting-screen image 271 shown in FIG. 6 is a setting-screen image used for determining whether the value of an output transmitted to the TV having the D terminal should be determined to be [D1] or [D3]. The component-output-setting-screen image 271 shows a D1-setting icon 272 used for determining the value of a component output to be D1 and a D3-setting icon 273 used for determining the component-output value to be D3. When the user selects either of the D1-setting icon 272 and the D3-setting icon 273, information about the selection is transmitted to the control unit, and settings on the device are made under the control of the control unit.

For example, when an HD image is output, the output value is determined to be [D3], and when an SD image is output, the output value is determined to be [D1]. The configuration of the above-described determination corresponds to those of the cable-connection-hint-screen images 251a to 251c shown in FIG. 5. That is to say, according to FIG. 5, the cable-connection settings are made only for a high-definition TV that can output an HD image. Further, as shown in each of the cable-connection-hint-screen images 251a and 251c, the hint information suggests the user determine the component-output value to be [D3].

The user selects the D3-setting icon 273 on the component-output-setting-screen image 271 shown in FIG. 6. Subsequently, information about the above-described selection is transmitted to the control unit, and the value of the component output of the device is determined to be [D3] under the control of the control unit.

After the user selects the D3-setting icon 273 on the component-output-setting-screen image 271 so that the value of the component output is determined to be [D3], the user can return to the cable-connection-hint-screen image 251 shown in FIG. 5 by operating a screen-image-return icon 274 shown on the component-output-setting-screen image 271.

Further, the user can return to the cable-confirmation-screen image 231 shown in FIG. 4 by operating a screen-image-return icon 263 shown on the cable-connection-hint-screen image 251 shown in FIG. 5. When the user operates an OK icon 243 shown on the cable-confirmation-screen image 231 shown in FIG. 4, the control unit displays a connection-completion-confirmation-screen image on the display unit 180 based on information about the above-described operation.

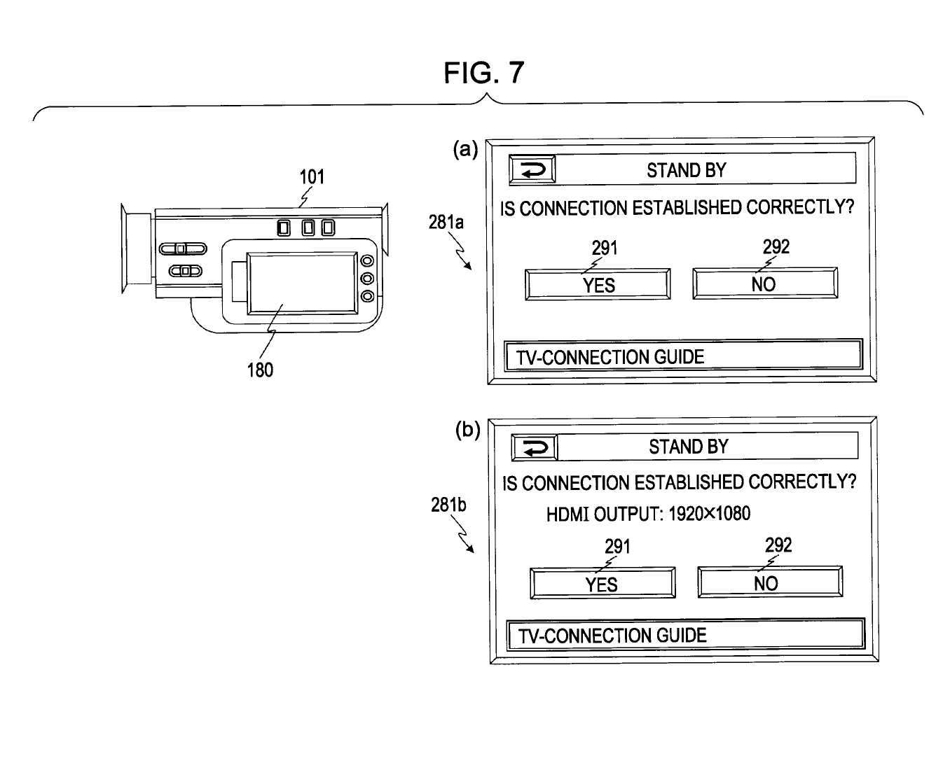

FIG. 7 shows two types of connection-completion-confirmation-screen images 281a and 281b, for example. Each of the connection-completion-confirmation-screen images 281a and 281b shows a [yes icon] 291 and a [no icon] 292, so as to confirm whether or not the cable connection was achieved correctly. The user operates either the [yes icon] 291 or the [no icon] 292 based on a result of the cable-connection confirmation.

Upon receiving information about the above-described icon operation, the control unit performs the processing corresponding to the icon operation. For example, if information about the operation performed for the [yes icon] 291 is detected, it is determined that the cable connection is achieved correctly, and the function of [TV-connection guide] is terminated. For example, guide information shown on the display unit 180 is deleted, or processing is performed to return to a menu-display-screen image, for example. On the other hand, if information about the operation performed for the [no icon] 292 is detected, the control unit determines that the cable connection is not achieved correctly and performs processing to return to one of the cable-confirmation-screen images 231a to 231c shown in FIG. 4.

The difference between the connection-completion-confirmation-screen images 281a and 281b shown in FIG. 7 will be described below. Namely, the connection-completion-confirmation-screen image 281b shows information about a resolution of [e.g., 1920×1080], as information about the format of data output to the output-destination device (TV) under the HDMI standard. When the cable connection is performed by using the HDMI terminal, it becomes possible to input information transmitted from the data-output-destination device, and the information corresponding to the output status is displayed based on the input information. The above-described display information is generated by the control unit of the information-processing device 101.

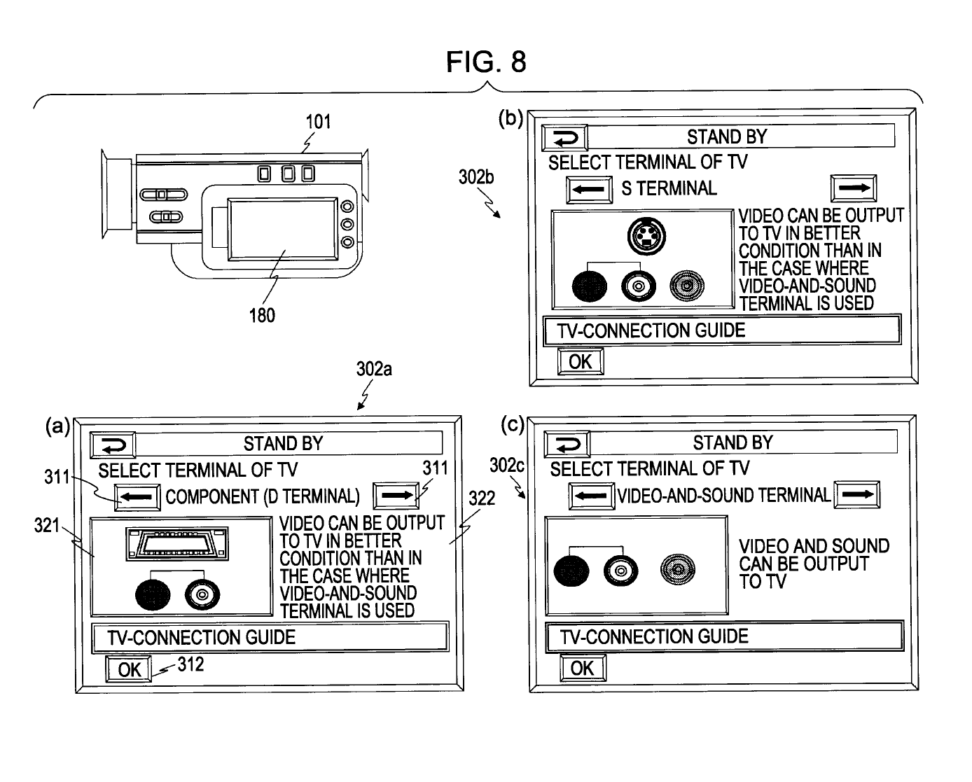

Next, with reference to FIG. 8 and later drawings, example guide processing will be described. The example guide processing is performed when the user selects [wide and/or 4:3 TV] on the TV-connection-guide-initial-screen image 201 described with reference to FIG. 2, where the TV-connection-guide-initial-screen image 201 is provided so that the user inputs information about to which of the two categories:

[high-definition TV], and

[wide and/or 4:3 TV]

the TV functioning, as the device for connection, belongs.

When the user selects the category [wide and/or 4:3 TV] on the TV-connection-guide-initial-screen image 201 shown in FIG. 2, the control unit of the information-processing device 101 detects information about the selection operation, performs the display-information switching, and displays three types of terminal-selection-screen images 302a, 302b, and 302c shown in FIG. 8 on the display unit 180. Each of the three types of terminal-selection-screen images 302a to 302c shown in FIG. 3 is ready for the category [wide and/or 4:3 TV]. It becomes possible to switch between the terminal-selection-screen images 302a to 302c in sequence by operating a screen-image-switching icon 311.

Each of the terminal-selection-screen images 302a to 302c shown in FIG. 8 is a screen image by which the user can confirm the type of at least one terminal provided on the wide and/or 4:3 TV when the user selects the wide and/or 4:3 TV, as a device that is to be connected to the information-processing device 101 via a cable.

Each of the terminal-selection-screen images 302a to 302c includes image data 321 on terminals of the device for connection and data 322 on descriptions of what can be done by using the terminals. According to FIG. 8, it is possible to switch between the three types of terminal-selection-screen images 302a to 302c corresponding to three types of terminals including:

(a) component (D terminal)

(b) S terminal, and

(c) video-and-sound terminal.

According to the above-described embodiment, the three types of terminal-selection-screen images 302a to 302c are switched from one another and displayed separately. However, the terminal-selection-screen images 302a to 302c may be aligned and displayed.

The terminal-image data 321 relating to the device for connection is data on an image of terminals provided on the TV functioning, as the device for connection. Therefore, the user can confirm the shapes of the terminals of the TV and select the terminals matching with the confirmed terminals from the image data provided on each of the terminal-selection-screen images 302a to 302c. Here, if terminals of at least two types are provided on the TV, any of the terminals may be selected. For example, an appropriate terminal can be selected with reference to the description data 322.

For example,

data on the description of (a) component (D terminal) is written, as “Video can be output to TV in better condition than in the case where video-and-sound terminal is used”,

data on the description of (b) S terminal is written, as “Video can be output to TV in better condition than in the case where video-and-sound terminal is used”, and

data on the description of (c) video-and-sound terminal is written, as “Video and sound are output to TV”.

Each of the above-described description data includes information about the characteristics, advantage, and cautions in outputting data through the connection achieved by using each of the terminals. Subsequently, the user can select an appropriate cable terminal based on the above-described descriptions.

The user inputs selection information by operating an OK icon 312, so as to select a single terminal from among terminals shown on the terminal-selection-screen images 302a to 302c shown in FIG. 8, as a selection terminal. When the control unit of the information-processing device 101 detects the selection information input by the user, the control unit selects and displays the next guide-screen image corresponding to the selection information input by the user on the display unit 180.

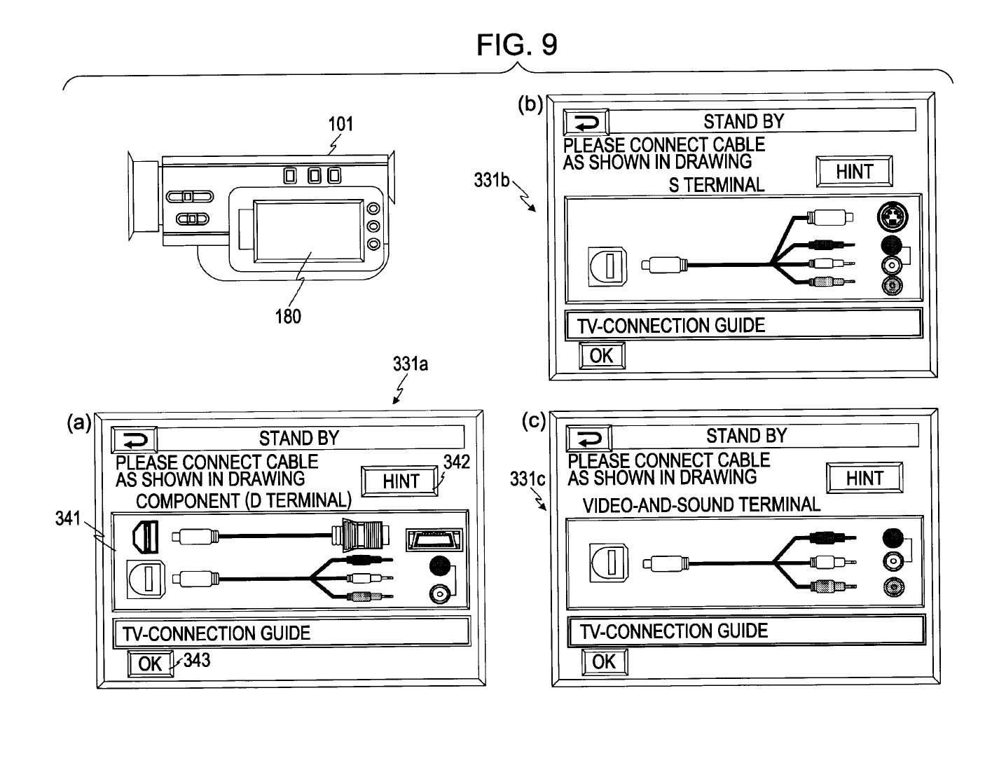

FIG. 9 shows example display-screen images obtained when the OK icon 312 is operated on the three terminal-selection-screen images 302a to 302c shown in FIG. 8, the terminal-selection-screen images 302a to 302c showing

(a) Component (D terminal)

(b) S terminal, and

(c) Video-and-sound terminal.

FIG. 9 shows the cable-confirmation-screen images 331a, 331b, and 331c corresponding to the three terminal-selection-screen images 302a to 302c shown in FIG. 8. Each of the three types of cable-confirmation-screen images 331a to 331c shown in FIG. 9 is a screen image shown on the display unit 180 when one of the above-described three types of terminals including:

(a) Component (D terminal),

(b) S terminal, and

(c) Video-and-sound terminal

is selected, namely, when the OK icon 312 shown in one of the terminal-selection-screen images 302a to 302c shown in FIG. 8 is operated. Subsequently, the user can confirm the cable corresponding to the selected terminal by viewing each of the cable-confirmation-screen images 331a to 331c.

The cable-confirmation-screen images 331a to 331c shown in FIG. 9 are provided so that the user can confirm a cable that can be used for connecting the information-processing device 101 which is a data-output-source device to the TV which is a data-output-destination device according to the above-described embodiment.

Each of the cable-confirmation-screen images 331a to 331c includes cable-connection-image data 341 showing at least one cable appropriate for establishing a connection, and the correspondence between the at least one appropriate cable and terminals of devices that are to be connected to both ends of the appropriate cable. The cable-connection-image data 341 includes not only the image data on the at least one cable but also image data on the terminals of devices that are to be connected to the at least one cable. Image data on at least one terminal of each of two devices connected to each other via the cable, namely, terminals of the information-processing device or the image-pickup device functioning, as the data-output-source device, and the data-output-destination device which is the TV in the above-described embodiment are displayed so that the correspondence between the above-described terminals and connection ends of the cable is displayed. The user can select the cable displayed, as the cable-connection-image data 341, and confirm the shape of each of the terminals of the TV and/or the image-pickup device, where the terminals are shown, as the cable-connection-image data 341. Subsequently, the user can perform the cable connection correctly by selecting at least one appropriate cable and determining the connection orientation with certainty.

Further, as shown in FIG. 9, a hint-call icon 342 is provided on each of the cable-confirmation-screen images 331a to 331c. When the user operates the hint-call icon 342, a hint-screen image showing information about the cable connection is presented. Namely, when the control unit of the information-processing device 101 detects information about the operation performed by the user for the hint-call icon 342, the control unit displays the hint-screen image on the display unit 180.

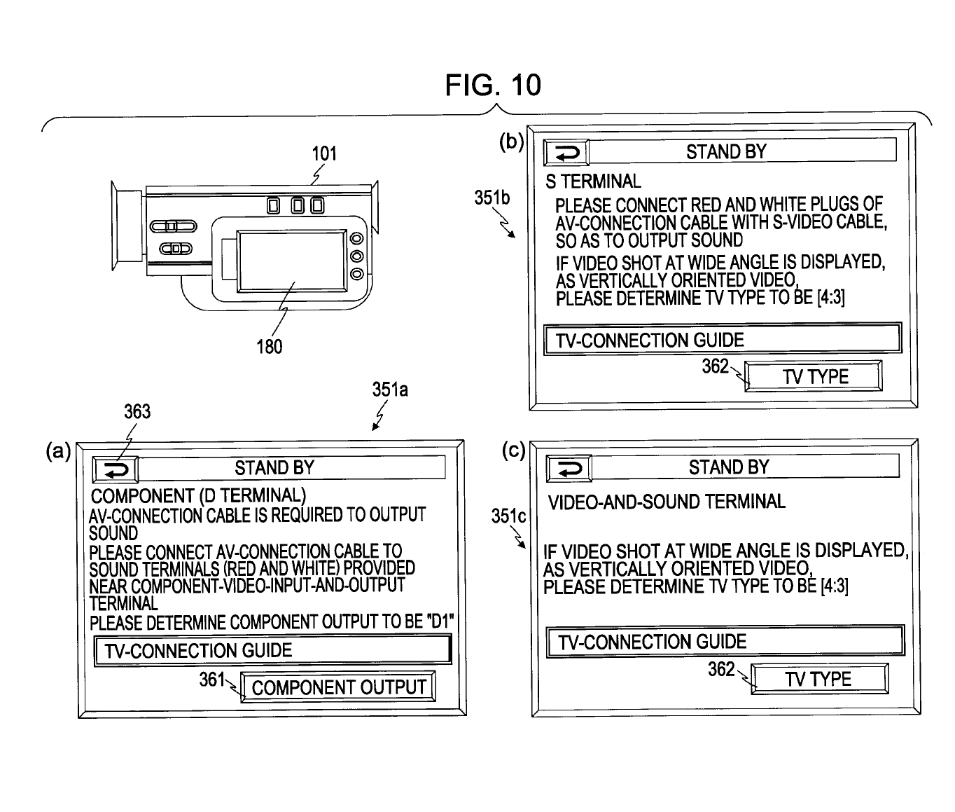

Parts (a), (b), and (c) of FIG. 10 show the cable-connection-hint-screen images 351a, 351b, and 351c, corresponding to the three types of cable-confirmation-screen images 331a, 331b, and 331c shown in FIG. 9, for example. The cable-connection-hint-screen images 351a to 351c shown in FIG. 10 correspond to the terminal-selection-screen images 302a to 302c shown in FIG. 8 and the cable-confirmation-screen images 331a to 331c. Further, the cable-connection-hint-screen images 351a to 351c correspond to the cable-connection methods achieved by using the three types of terminals including:

(a) Component (D terminal),

(b) S terminal, and

(c) Video-and-sound terminal.

Part (a) of FIG. 10 shows hint information relating to the cable-connection method achieved by using the component (D terminal). More specifically, the hint information is read, as

“AV-connection cable is required to output sound data. Please connect AV-connection cable to sound terminals (red and white) provided near Component-video-input-and-output terminal. Please determine component output to be “D1””.

Further, Part (b) of FIG. 10 shows hint information relating to the cable-connection method achieved by using the S terminal. More specifically, the hint information is read, as

“Please connect red and white plugs of AV-connection cable with S-video cable, so as to output sound data. If video shot at wide angle is displayed, as vertically oriented video, please determine TV type to be [4:3]”.

Further, part (c) of FIG. 10 shows hint information relating to the cable-connection method achieved by using the video-and-sound terminal. More specifically, the hint information is read, as

“If video shot at wide angle is displayed, as vertically oriented video, please determine TV type to be [4:3]”.

The above-described hint information is presented, as the hint information corresponding to each of the terminals and/or the cables.

Thus, each of the cable-connection-hint-screen images 351a to 351c is provided with hint information including information about a detailed description, cautions, settings used to achieve the cable connection, and so forth. If settings are to be made to achieve the cable connection, an icon is displayed on each of the cable-connection-hint-screen images 351a to 351c, the icon being used for shifting to a setting-screen image. More specifically, a component-output icon 361 is shown in part (a) of FIG. 10, and a TV-type icon 362 is shown in each of parts (b) and (c) of FIG. 10.

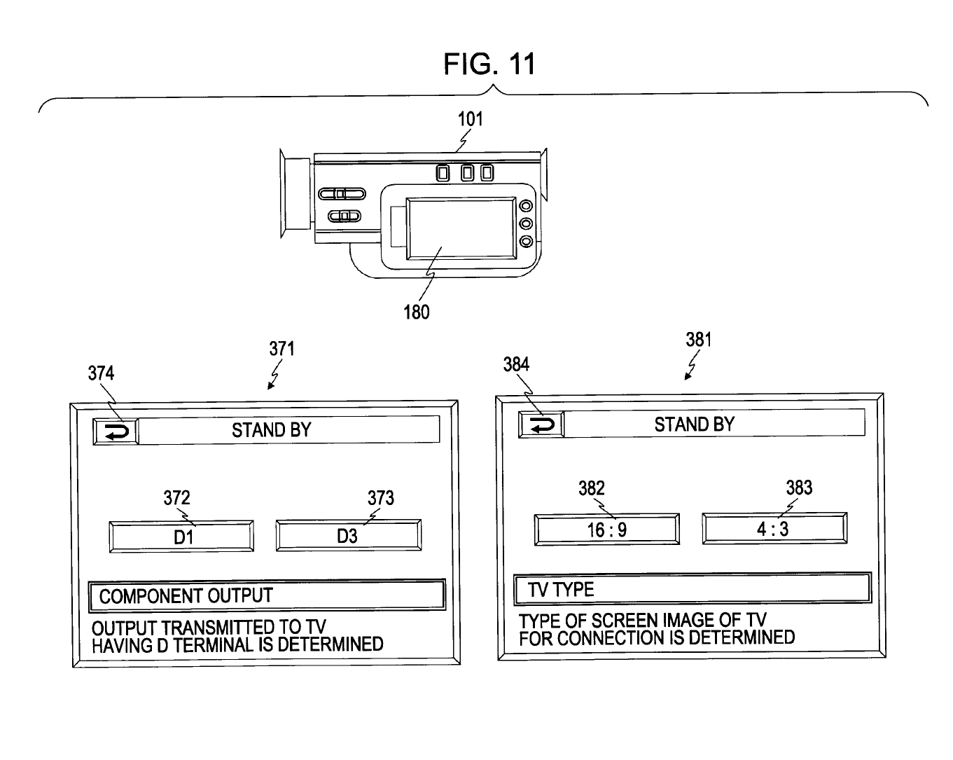

When the user operates the above-described icons provided to make the settings, the control unit detects information about the above-described operation and shifts to a device-setting-processing-screen image used to achieve the cable connection. FIG. 11 shows examples of the above-described device-setting-processing-screen image. Namely, FIG. 11 shows a component-output-setting-screen image 371 and a TV-type-setting-screen image 381, as device-setting-screen images displayed on the display unit 180, for example.

The component-output-setting-screen image 371 shown in FIG. 11 is a setting-screen image used to determine whether the value of an output transmitted to the TV having the D terminal is determined to be [D1] or [D3]. The component-output-setting-screen image 371 shows a D1-setting icon 372 used to determine the value of a component output to be [D1] and a D3-setting icon 373 used to determine the component-output value to be [D3]. When the user selects either of the D1-setting icon 372 and the D3-setting icon 373, information about the selection is transmitted to the control unit, and settings on the device are made under the control of the control unit.

For example, when an HD image is output, the output value is determined to be [D3], and when an SD image is output, the output value is determined to be [D1]. The configuration of the above-described determination corresponds to those of the cable-connection-hint-screen images 351a to 351c shown in FIG. 10. That is to say, according to FIG. 10, the cable-connection settings are made for the wide and/or 4:3 TV rather than the high-definition TV. Further, as shown in the cable-connection-hint-screen image 351a, the hint information suggests the user determine the component-output value to be [D1].

The user selects the D1-setting icon 372 on the component-output-setting-screen image 371 shown in FIG. 11. Subsequently, information about the above-described selection is transmitted to the control unit, and the value of the component output of the device is determined to be [D1] under the control of the control unit.

After the user selects the D1-setting icon 372 on the component-output-setting-screen image 371 so that the value of the component output is determined to be [D1], the user can return to the cable-connection-hint-screen image 351a shown in FIG. 10 by operating a screen-image-return icon 374 shown on the component-output-setting-screen image 371.

When the user operates the TV-type icon 362 on each of the cable-connection-hint-screen images 351b and 351c shown in parts (b) and (c) of FIG. 10, the control unit detects information about the above-described operation and displays the TV-type-setting-screen image 381 shown in FIG. 11 on the display unit 180.

The TV-type-setting-screen image 381 shown in FIG. 11 is used to select the type of a TV functioning, as the output destination. Namely, the TV-type-setting-screen image 381 is provided so that the user can confirm whether the aspect ratio of the output-destination TV is [16:9] or [4:3] and selects the aspect ratio. A 16:9-setting icon 382 used to determine the TV type to be [16:9] and a 4:3-setting icon 383 used to determine the TV type to be [4:3] are shown on the TV-type-setting-screen image 381. When the user selects either of the 16:9-setting icon 382 and the 4:3-setting icon 383, information about the selection is transmitted to the control unit, and settings on the device are made under the control of the control unit.

When the user selects either of the above-described TV-type-setting icons 382 and 383 shown on the TV-type-setting-screen image 381, the TV type is determined to be [16:9], or [4:3]. After that, the user can return to either of the cable-connection-hint-screen image 351b and the cable-connection-hint-screen image 351c that are shown in FIG. 10 by operating a screen-image-return icon 384 shown on the TV-type-setting-screen image 381.

Further, the user can return to the cable-confirmation-screen image 331 shown in FIG. 9 by operating a screen-image-return icon 363 shown on each of the cable-connection-hint-screen images 351a to 351c shown in FIG. 10. When the user operates an OK icon 343 shown on each of the cable-confirmation-screen image 331a to 331c shown in FIG. 9, the control unit displays a connection-completion-confirmation-screen image on the display unit 180 based on information about the above-described operation.

As described above, FIG. 7 shows the two types of connection-completion-confirmation-screen images 281a and 281b, for example. Each of the connection-completion-confirmation-screen images 281a and 281b shows the [yes icon] 291 and the [no icon] 292, so as to make the user confirm whether or not the cable connection was achieved correctly. The user operates either the [yes icon] 291 or the [no icon] 292 based on a result of the cable-connection confirmation.

Upon receiving information about the above-described icon operation, the control unit performs the processing corresponding to the icon operation. For example, if information about the operation performed for the [yes icon]291 is detected, it is determined that the cable connection is achieved correctly, and the function of [TV-connection guide] is terminated. For example, guide information shown on the display unit 180 is deleted, or processing is performed to return to the menu-display-screen image, for example. On the other hand, if information about the operation performed for the [no icon] 292 is detected, the control unit determines that the cable connection is not achieved correctly and performs an operation, so as to return to one of the cable-confirmation-screen images 331a to 331c shown in FIG. 9.

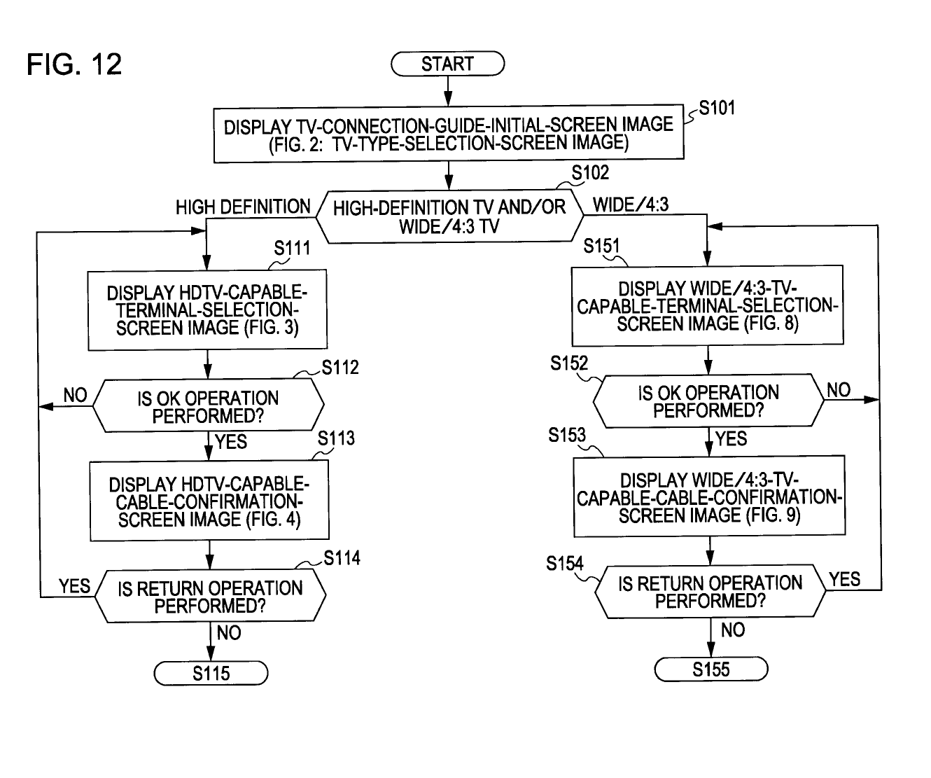

Next, a cable-connection-guide sequence performed by the information-processing device 101 provided, as the image-pickup device, of the above-described embodiment will be described with reference to flowcharts shown in FIGS. 12 to 15. The above-described cable-connection-guide processing is performed under the control of the control unit of the information-processing device 101 according to a program stored in a storage unit provided in the information-processing device 101.

First, the TV-connection-guide-initial screen image 201 described with reference to FIG. 2 is displayed on the display unit 180, at step S101. The TV-connection-guide-initial screen image 201 is provided so that the user can select the type of a TV for connection. Namely, the user inputs information about to which of the two categories including:

[high-definition TV] and

[wide and/or 4:3 TV]

the TV belongs on the TV-connection-guide-initial-screen image 201.

At step S102, the control unit of the information-processing device 101 determines which of the categories [high-definition TV] and [wide and/or 4:3 TV] is selected by the user. If the category [high-definition TV] is selected, the processing corresponding to step S111 and later is performed and if the category [wide and/or 4:3 TV] is selected, the processing corresponding to step S151 and later is performed.

First, the processing corresponding to steps S111, S112, S113, and S114 will be described, where the processing is performed when the category [high-definition TV] is selected. If it is determined that the user selects the category [high-definition TV], at step S102, the control unit of the information-processing device 101 displays HDTV-capable-terminal-selection-screen images, at step S111. Each of the HDTV-capable-terminal-selection-screen images includes the above-described terminal-image data 221 and description data 222 described with reference to FIG. 3. For example, the three types of terminal-selection-screen images corresponding to the following three types of terminals including:

(a) Component (D terminal),

(b) HDMI terminal, and

(c) Component (pin terminal)

are shown in a switchable manner and/or list form.

At step S112, the control unit detects whether or not the OK icon shown on the terminal-selection-screen image displayed, at step S111, is operated. If it is determined that the OK icon is operated, the processing advances to step S113 so that HDTV-capable-cable-confirmation-screen images are displayed.

The above-described HDTV-capable-cable-confirmation-screen images are the cable-confirmation-screen images 231a to 231c described with reference to FIG. 4, the cable-confirmation-screen images 231a to 231c including the cable-connection-image data 241 showing the at least one cable appropriate for connection, and the correspondence between the at least one appropriate cable and the terminals of the devices that are to be connected to both ends of the appropriate cable. The user can select the cable shown in the cable-connection-image data 241, and confirm the shape of the terminals of the TV and/or the image-pickup device, the terminals being shown, as the cable-connection-image data 241. Subsequently, the user can perform the cable connection correctly by selecting the cable and determining the connection orientation with certainty.

At step S114, the control unit detects whether or not a return icon shown on the cable-confirmation-screen image displayed, at step S113, is operated. When the return icon is operated, the processing returns to step S111 and the terminal-selection-screen image is displayed. If it is determined that the return icon is not operated, at step S114, the processing advances to step S115.

On the other hand, if it is determined that the user selects [wide and/or 4:3 TV], at step S102, the processing corresponding to step S151 and later is performed. In that case, the control unit displays wide-and/or-4:3-TV-capable-terminal-selection-screen images, at step S151. Each of the wide-and/or-4:3-TV-capable-terminal-selection-screen images includes the terminal-image data 321 and the description data 322 that are described with reference to FIG. 8. For example, the three types of terminal-selection-screen images corresponding to the following three types of terminals including:

(a) Component (D terminal),

(b) S terminal, and

(c) Video-and-sound terminal

are shown in a switchable manner and/or list form.

At step S152, the control unit detects whether or not the OK icon shown on the terminal-selection-screen image displayed, at step S151, is operated. If it is determined that the OK icon is operated, the processing advances to step S153 so that wide-and/or-4:3-TV-capable-cable-confirmation-screen images are displayed.

The above-described wide-and/or-4:3-TV-capable-cable-confirmation-screen images are the cable-confirmation-screen images 331a to 331c described with reference to FIG. 9. Each of the cable-confirmation-screen images 331a to 331c includes the cable-connection-image data 341 showing the at least one cable appropriate for connection, and the correspondence between the at least one appropriate cable and the terminals of the devices that are to be connected to both ends of the appropriate cable. The user can select the cable shown, as the cable-connection-image data 341, and confirm the shapes of the terminals of the TV and/or the image-pickup device, the terminals shown, as the cable-connection-image data 341. Subsequently, the user can perform the cable connection correctly by selecting the cable and determining the connection orientation with certainty.

At step S154, the control unit detects whether or not a return icon shown on the cable-confirmation-screen image displayed, at step S153, is operated. When the return icon is operated, the processing returns to step S151 and the terminal-selection-screen image is displayed. If it is determined that the return icon is not operated, at step S154, the processing advances to step S155.

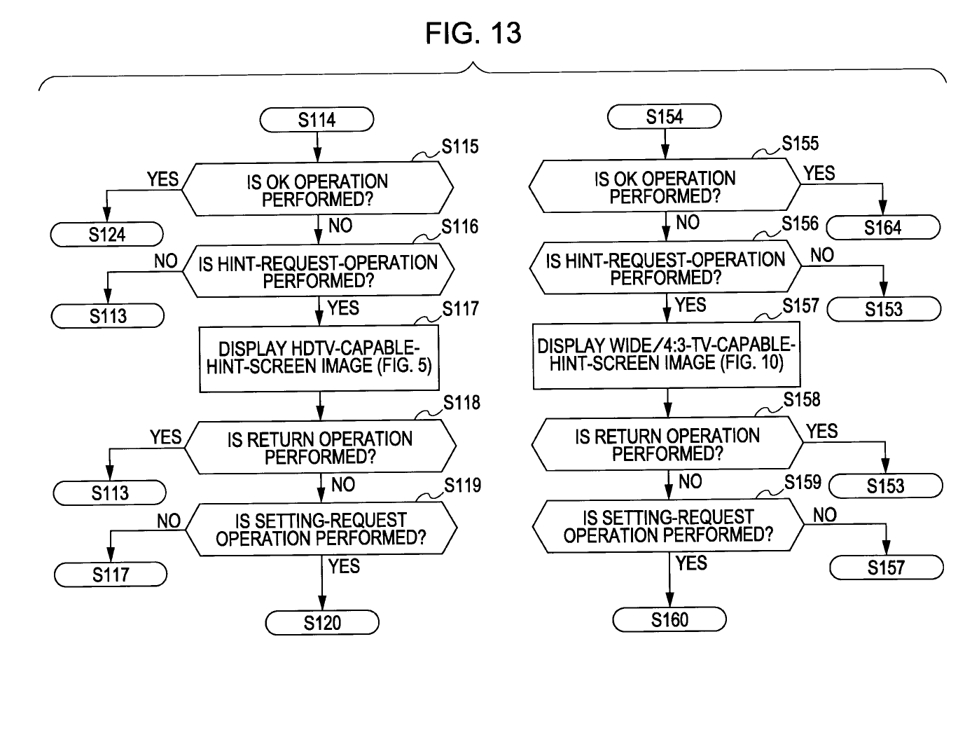

Next, the next processing sequence will be described with reference to a flowchart of FIG. 13. First, the processing corresponding to steps S115, S116, S117, S118, and S119 will be described. The above-described processing is performed when the high-definition TV is selected, as the output destination.

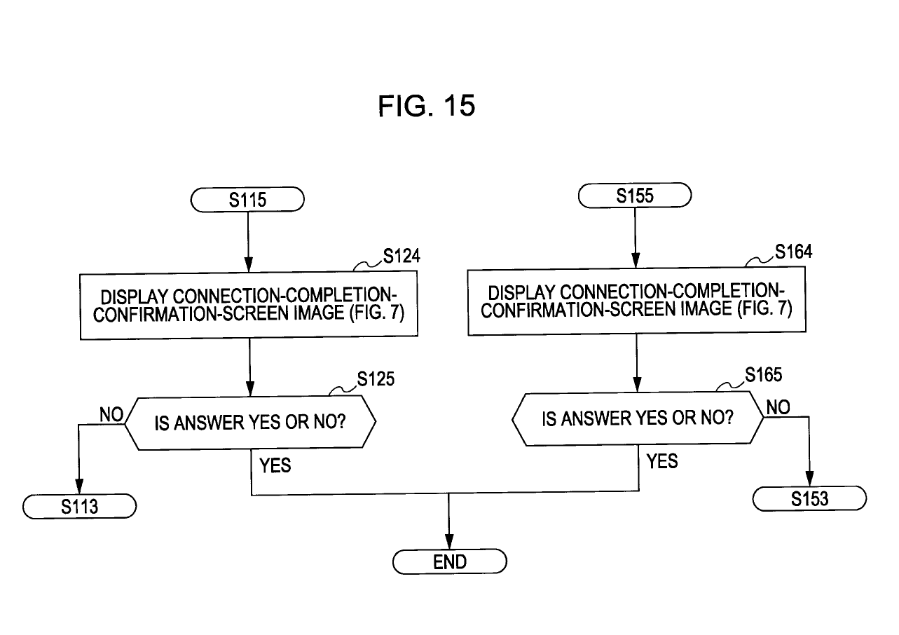

At step S115, it is detected whether or not the OK icon is operated on each of the cable-confirmation-screen images 231a to 231c shown in FIG. 4, the cable-confirmation-screen images 231a to 231c being displayed, at step S113. If it is determined that the OK icon is operated, the processing advances to step S124. The processing corresponding to step S124 is performed when each of the connection-completion-confirmation-screen images 281a and 281b shown in FIG. 7 is displayed. The above-described processing corresponding to step S124 will be described later with reference to FIG. 15.

At step S115, if the OK icon is not operated in each of the cable-confirmation-screen images 231a to 231c shown in FIG. 4, the cable-confirmation-screen images 231a to 231c being displayed, at step S113, the processing advances to step S116 so that whether or not a hint-request operation is performed is detected. Namely, it is detected whether or not the hint-call icon 242 shown on each of the cable-confirmation-screen images 231a to 231c shown in FIG. 4 is operated. If it is detected that the hint-call icon 242 is operated, the processing advances to step S117 so that cable-connection-hint-screen images are displayed.

The cable-connection-hint-screen images displayed, at step S117, are the cable-connection-hint-screen images 251a to 251c described with reference to FIG. 5. As illustrated in FIG. 5, the hint information includes information about a detailed description, cautions, settings that are used to achieve the cable connection.

At step S118, it is detected whether or not a return operation is performed. If it is detected that the return operation is operated, the processing returns to step S113 where the HDTV-capable-cable-confirmation-screen images 231a to 231c shown in FIG. 4 are displayed.

Further, if it is detected that a setting-request operation is performed on each of the cable-connection-hint-screen images 251a to 251c, at step S119, namely, if it is detected that the component-output icon 261 described with reference to FIG. 5 is operated, the processing advances to step S120.

Next, the processing corresponding to steps S155 to S159 performed when the wide and/or 4:3 TV is selected, as the output destination, will be described.

At step S155, it is detected whether or not the OK icon is operated on each of the cable-confirmation-screen images 331a to 331c shown in FIG. 9, the cable-confirmation-screen images 331a to 331c being displayed, at step S153. If it is detected that the OK icon is operated, the processing advances to step S164. The processing corresponding to step S164 is performed when each of the connection-completion-confirmation-screen images 281a and 281b shown in FIG. 7 is displayed. The above-described processing corresponding to step S164 will be described later with reference to FIG. 15.

At step S155, if the OK icon is not operated on each of the cable-confirmation-screen images 331a to 331c shown in FIG. 9, the cable-confirmation-screen images 331a to 331c being displayed, at step S153, the processing advances to step S156 so that whether or not a hint-request operation is detected. Namely, it is detected whether or not the hint-call icon 342 shown on each of the cable-confirmation-screen images 331a to 331c shown in FIG. 9 is operated. If it is detected that the hint-call icon 242 is operated, the processing advances to step S157 so that cable-connection-hint-screen images are displayed.

The cable-connection-hint-screen images displayed, at step S157, are the cable-connection-hint-screen images 351a to 351c described with reference to FIG. 10. As illustrated in FIG. 10, the hint information includes information about a detailed description, cautions, settings used to achieve the cable connection.

At step S158, it is detected whether or not a return operation is performed. If it is detected that the return operation is performed, the processing returns to step S153 where the wide-and/or-4:3-TV-capable-cable-confirmation-screen images 331a to 331c shown in FIG. 9 are displayed.

Further, if it is detected that a setting-request operation is performed on each of the cable-connection-hint-screen images 351a to 351c, at step S159, namely, if it is detected that the component-output icon 361 shown in part (a) of FIG. 10 and/or the TV-type icon 362 shown in each of parts (b) and (c) shown in FIG. 10 is operated, the processing advances to step S160.

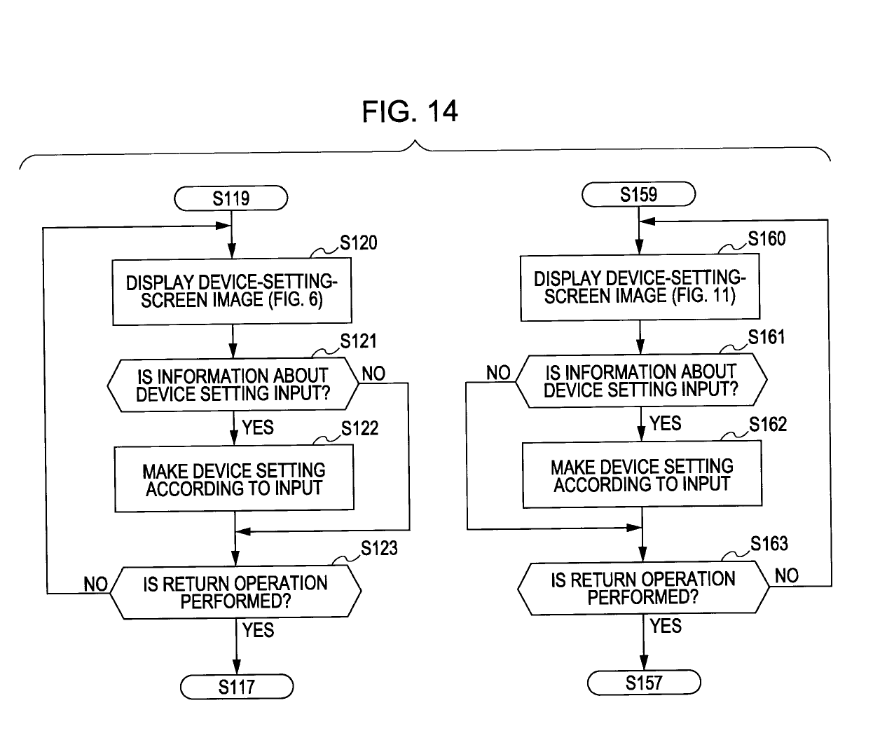

Next, the processing sequence following the above-described processing will be described with reference to a flowchart of FIG. 14. First, the processing corresponding to steps S120, S121, S122, and S123 will be described. The above-described processing is performed when the high-definition TV is selected, as the output destination.

The processing corresponding to step S120 is performed when it is detected that a setting-request operation is performed on each of the cable-connection-hint-screen images 251a to 251c, at step S119, namely, when it is detected that the component-output icon 261 described with reference to FIG. 5 is operated. In that case, a device-setting-screen image is displayed, at step S120. The above-described device-setting-screen image corresponds to the component-output-setting-screen image 271 described with reference to FIG. 6. The device-setting-screen image is displayed so that the user selects either [D1] or [D3], as an output transmitted to a TV having the D terminal.

The control unit determines whether or not information about a setting request is input on the device-setting-screen image, at step S121. For example, the control unit detects whether or not a setting request is issued for [D1] and/or [D3]. If it is determined that the setting-request information is input, at step S121, the device-setting processing corresponding to the input setting request is performed.

Next, at step S123, it is determined whether or not a return operation is performed on the device-setting-screen image. Namely, it is detected whether or not a screen-image-return icon is operated. If it is determined that the screen-image-return icon is operated, the processing returns to step S117 where the HDTV-capable cable-connection-hint-screen images 251a to 251c are shown.

Next, the processing corresponding to steps S160 to S163 performed when the wide and/or 4:3 TV shown in FIG. 14 is selected, as the output destination, will be described.

The processing corresponding to step S160 is performed when it is detected that a setting-request operation is performed on each of the cable-connection-hint-screen images 351a to 351c, namely, when it is detected that the component-output icon 361 and/or the TV-type icon 362 described with reference to FIG. 10 is operated, at step S159 shown in the flowchart of FIG. 13. In that case, the device-setting-screen image is displayed, at step S160. The device-setting-screen image corresponds to the component-output-setting-screen image 371 and/or the TV-type-setting-screen image 381 described with reference to FIG. 11.

The control unit determines whether or not information about a setting request is input on the device-setting-screen image, at step S161. For example, the presence or absence of a request to determine an output to be D1 and/or D3, and/or a request to determine the TV type to be 16:9 and/or 4:3 is detected. If it is determined that the setting-request information is input, at step S161, the device-setting processing corresponding to the input setting request is performed, at step S162.

Next, at step S163, it is detected whether or not a return operation is performed on the device-setting-screen image. Namely, it is detected whether or not the screen-image-return icon is operated. If it is determined that the screen-image-return icon is operated, the processing returns to step S157 where the wide-and/or-4:3-TV-capable cable-connection-hint-screen images 351a to 351c are shown.

Finally, processing performed when the connection-completion-confirmation-screen image 281a and/or the connection-completion-confirmation-screen image 281b shown in FIG. 7 is displayed will be described with reference to a flowchart shown in FIG. 15. When the OK icon is operated on any of the cable-confirmation-screen images 231a to 231c, at step S115 shown in FIG. 13, while settings on the HDTV connection are made, the processing advances to step S124 shown in FIG. 15.

At step S124, a connection-completion-confirmation-screen image is displayed, namely, the connection-completion-confirmation-screen images 281a and 281b described with reference to FIG. 7 are displayed. Namely, as shown in FIG. 7, the [yes icon] 291 and the [no icon] 292 are displayed in each of the connection-completion-confirmation-screen images 281a and 281b, so as to input information about a confirmation made by the user, the confirmation being made to determine whether or not the cable connection is performed correctly. The user operates either the [yes icon] 291 or the [no icon] 292 based on a result of the cable-connection confirmation.

Information about the above-described operation is input to the control unit. Subsequently, the control unit determines whether the operation information input by the user corresponds to [yes] or [no], at step S125. If the operation performed for the [yes icon] 291 is detected, it is determined that the cable connection is established correctly, and the function of the icon [TV-connection guide] is terminated. For example, guide information displayed on the display unit 180 is deleted. Otherwise, the control unit returns to the menu-display-screen image.

On the other hand, if the operation performed for the [no icon] 292 is detected, the control unit determines that the cable connection is not performed correctly, returns to step S113, and performs processing, so as to return to the cable-confirmation-screen images 231a to 231c shown in FIG. 4.

On the other hand, when the OK icon is operated on each of the cable-confirmation-screen images 331a to 331c, at step S155 shown in FIG. 13, while the connection settings are made when the wide and/or 4:3 TV is selected, as the output destination, the processing advances to step S164 shown in FIG. 15.

At step S164, at least one of the connection-completion-confirmation-screen images 281a and 281b described with reference to FIG. 7 is displayed. At step S165, the control unit determines whether the operation information input to the above-described connection-completion-confirmation-screen image 281a or 281b corresponds to [yes] or [no]. If the operation performed for the [yes icon] 291 is detected, it is determined that the cable connection is established correctly, and the function of the icon [TV-connection guide] is terminated. For example, guide information displayed on the display unit 180 is deleted. Otherwise, the control unit returns to the menu-display-screen image. On the other hand, if the operation performed for the [no icon] 292 is detected, the control unit determines that the cable connection is not performed correctly, returns to step S153, and performs processing, so as to return to the cable-confirmation-screen images 331a to 331c shown in FIG. 9.

Thus, the information-processing device 101 according to the above-described embodiment displays guide-screen images in sequence, the guide-screen images including:

(A) Selection-screen image (such as the TV-connection-guide-initial screen image 201 shown in FIG. 2) provided to select the type of the cable-connection device (e.g., a TV),

(B) Terminal selection-screen image (such as the terminal-selection screen images 202a, 202b, and 202c shown in FIG. 3, and the terminal-selection-screen images 302a, 302b, and 302c shown in FIG. 8) including image data on the shape of each of terminals provided on the cable-connection device,

(C) Cable-confirmation-screen image showing image data on at least one cable ready for the terminal and the correspondence between the cable and a connection terminal (such as the cable-confirmation-screen images 231a, 231b, and 231c shown in FIG. 4 and the cable-confirmation-screen images 331a, 331b, and 331c shown in FIG. 9), and

(D) Hint-screen image (such as the cable-connection-hint-screen images 251a, 251b, and 251c shown in FIG. 5 and the cable-connection-hint-screen images 351a, 351b, and 351c shown in FIG. 10).

Therefore, the user selects the type of the cable-connection device such as the TV and the shape of the terminal, and performs processing according to information shown on the guide-screen image. Subsequently, the user can perform the cable connection with facility and stability.

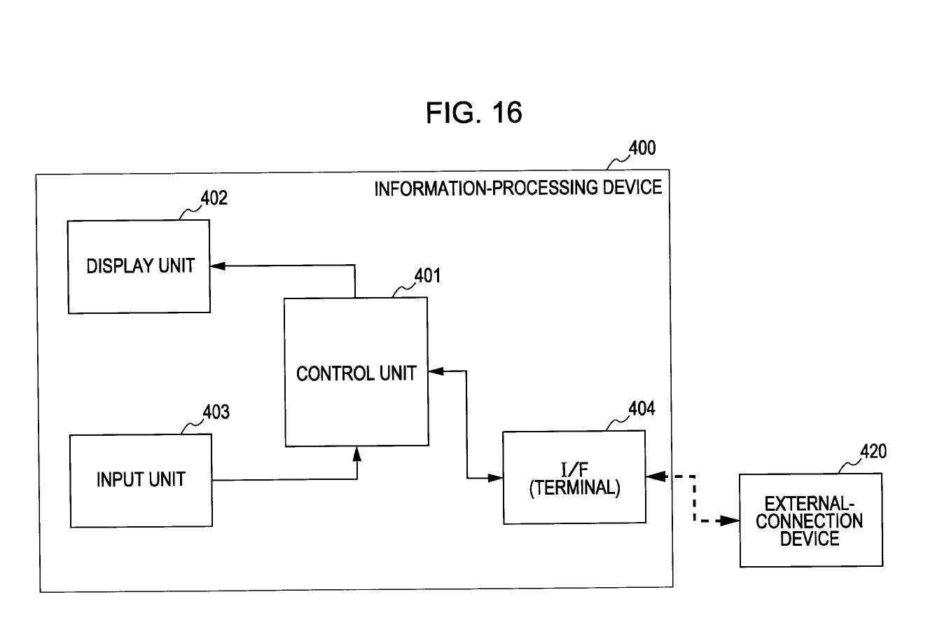

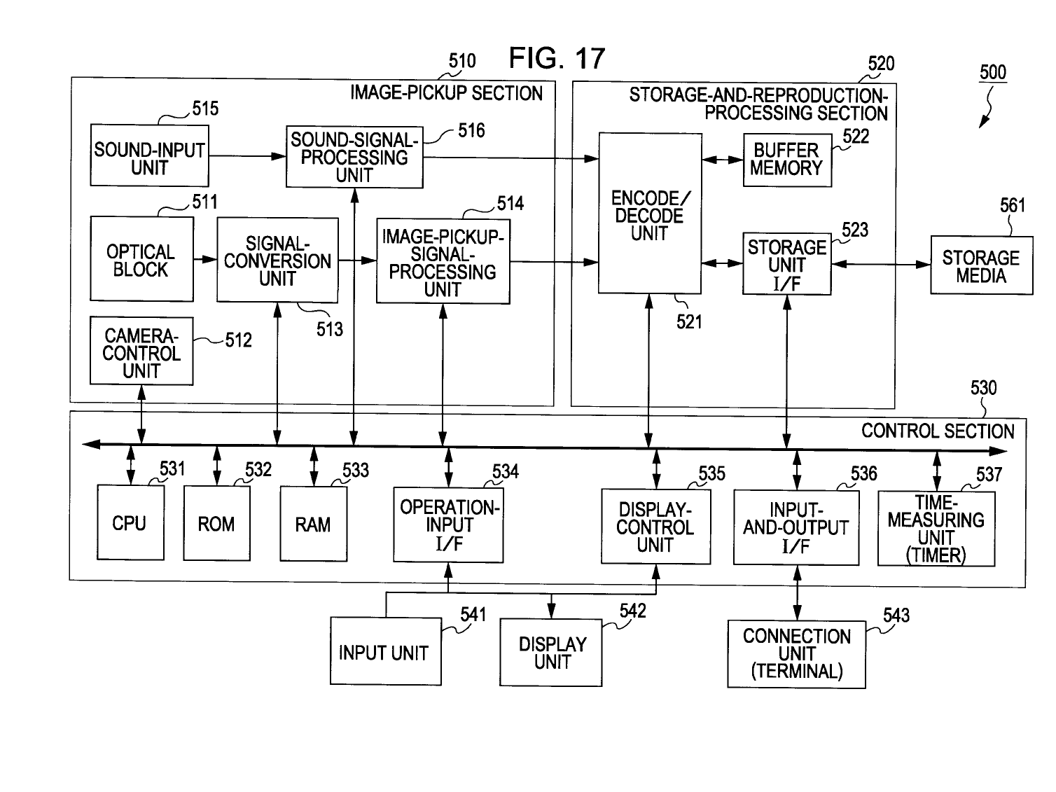

Finally, the configuration of an information-processing device 400 according to an embodiment of the present invention will be described with reference to FIGS. 16 and 17. FIG. 16 is a functional-block diagram illustrating functions of performing the above-described processing procedures. FIG. 17 shows an example hardware configuration of an image-pickup device 500 provided, as an example of the above-described information-processing device 400.

First, the functions of the above-described information-processing device 400 will be described with reference to the above-described functional-block diagram shown in FIG. 16. As shown in FIG. 16, the information-processing device 400 includes a control unit 401, a display unit 402, an input unit 403, and an interface 404 including terminals or the like. The information-processing device 400 is connected to an external-connection device 420 via a cable connected to the interface 404.

The control unit 401 is configured, as a central-processing unit (CPU), for example. The control unit 401 displays the above-described cable-connection-guide information on the display unit 402, detects information input by the user through the input unit 403, and makes various settings on the information-processing device 400.

The display unit 402 displays the above-described various cable-connection-guide information described with reference to FIGS. 2 to 11. The input unit 403 is provided so that the user can input information about an operation performed for an icon including an OK icon, a screen-image-return icon, a device-setting-screen-image-shift icon, and so forth. When the display unit 402 includes a touchpanel or the like by which the user can input information on a screen image shown on the display unit 402, the input unit 403 and the display unit 402 are integrated with each other.

The control unit 401 displays the TV-connection-guide-initial screen image 201 described with reference to FIG. 2 on the display unit 402, where the TV-connection-guide-initial screen image 201 is provided to confirm the type of a device to which a cable is connected. Then, the control unit 401 selects and displays the guide information corresponding to a specified device based on device-type-specification information input by the user.

Further, the control unit 401 displays external-device-terminal-image data on the display unit 402, where the external-device-terminal-image data indicates a plurality of external-device terminals that can be provided on the external-connection device 420 that is to be connected to the information-processing device 400 via the cable. Namely, as described with reference to FIGS. 3 and 8, the control unit 401 displays the terminal-image data 221 and/or 321 showing the shape of each of terminals provided on the data-output-destination device, and the terminal-selection-screen images 202a to 202c and/or the terminal-selection-screen images 302a to 302c including descriptions of the processing performed by using the displayed terminals. Further, based on information about selection of the external-device terminal, the information being input by the user via the input unit 403, the cable-confirmation-screen images 231a to 231c shown in FIG. 4 and/or the cable-confirmation-screen images 331a to 331c shown in FIG. 9 are displayed on the display unit 402. Each of the above-described cable-confirmation-screen images 231a to 231c and/or 331a to 331c shows the shape of the cable appropriate for the selected terminal and the shape of each of the connection terminals corresponding to ends of the cables.

Further, the control unit 401 displays the hint information described with reference to FIGS. 5 and 10, the hint information being used for establishing the cable connection. When the hint information includes the description of the device-setting processing, the device-setting-screen-image-shift icon used for shifting to the device-setting-processing-screen image is displayed on the hint-screen image. Further, when information about a device-setting request is input when the device-setting-screen image is displayed, the device-setting processing corresponding to the device-setting request is performed. For example, the component-output value is determined to be D1 and/or D3.

Further, when an image picked up by the information-processing device 400 and/or an image stored in the stored unit is displayed on the display unit 402, the control unit 401 superimposes guide information on the displayed image, as a translucent image.

Finally, as shown in FIG. 17, the image-pickup device 500 includes an image-pickup section 510, a storage-and-reproduction-processing section 520, and a control section 530, as main processing blocks. The image-pickup device 500 further includes storage media 561, an input unit 541, a display unit 542 configured to display the guide information described in the above-described embodiments, and a connection unit (terminal) 543 connected to an external device.

The control unit 401 shown in FIG. 16 corresponds to the control section 530 shown in FIG. 17. The display unit 402 shown in FIG. 16 corresponds to the display unit 542 shown in FIG. 17. The input unit 403 shown in FIG. 16 corresponds to the input unit 541 shown in FIG. 17.

The image-pickup section 510 includes an optical block 511, a camera-control unit 512, a signal-conversion unit 513, an image-pickup-signal-processing unit 514, a sound-input unit 515, and a sound-signal-processing unit 516. The optical block 511 includes a group of lenses used for picking up an image of a subject, an aperture-adjustment mechanism, a focus-adjustment mechanism, a zoom mechanism, a shutter mechanism, a flash mechanism, and a hand-shake-correction mechanism, and so forth. The camera-control unit 512 inputs a control signal through the control section 530, and generates a control signal transmitted to the optical block 511. Then, the camera-control unit 512 transmits the generated control signal to the optical block 511, and performs control including zoom control, shutter control, and exposure control.

The signal-conversion unit 513 includes an image-pickup element such as a charge-coupled device (CCD). A subject image transmitted through the optical block 511 is formed on the image-forming surface of the image-pickup element. The signal-conversion unit 513 receives an image-capture-timing signal transmitted from the control unit 530 in response to a shutter operation, converts the subject image formed on the image-forming surface into an image-pickup signal, and transmits the image-pickup signal to the image-pickup-signal-processing unit 514.

The image-pickup-signal-processing unit 514 performs processing including gamma correction and/or auto-gain control (AGC) for the image-pickup signal based on the control signal transmitted from the control unit 530, and converts the image-pickup signal into an image signal generated, as a digital signal. The sound-input unit 515 collects data on sound near the subject while the subject image is picked up. A sound signal transmitted from the above-described sound-input unit 515 is transmitted to the sound-signal-processing unit 516. The sound-signal-processing unit 516 performs processing including correction and/or AGC for the sound signal based on the control signal transmitted from the control section 530, and converts the sound signal into a digital signal.

The storage-and-reproduction-processing section 520 includes an encode/decode unit 521, a buffer memory 522, and a storage-unit interface 523. The buffer memory 522 includes a synchronous dynamic random access memory (SDRAM), for example, and is used, as a work area used by the encode/decode unit 521 to encode and/or decode a signal. The encode/decode unit 521 has an encode function to encode and multiplex an image signal and a sound signal, and/or added-storage information transmitted from the image-pickup section 510 into compressed data. On the other hand, the encode/decode unit 521 has a decode function to separate the image signal and the sound signal, and/or the added-storage information from the compressed data, and decode the image signal and the sound signal, and/or the added-storage information. Further, the encode/decode unit 521 further performs automatic-white-balance control, exposure-correction control, enlarge control according to a digital-zoom magnification, and so forth for an image signal transmitted from the image-pickup-signal-processing unit 514 based on the control signal transmitted from the control section 530.

Upon receiving the compressed data transmitted from the encode/decode unit 521, the storage-unit interface 523 writes the compressed data into the storage media 561. Further, the storage-unit interface 523 reads the compressed data from the storage media 561 and transmits the compressed data to the encode/decode unit 521 and/or the control section 530.

The control section 530 outputs data decoded by the encode/decode unit 521 to an external device including a TV or the like connected to the control section 530 via a cable provided on the connection unit (terminal) 543 via an input-and-output I/F 536.

The control section 530 includes a CPU 531 configured to execute various control programs, a read-only memory (ROM) 532, a random-access memory (RAM) 533, an operation-input interface 534 used for connecting the input unit 541, a display-control unit 535 performing display control over the display unit 542 configured to display the above-described various guide information, the input-and-output I/F 536 used for inputting and/or outputting data by using the connection unit 543, and a clock circuit 537 used for measuring the image-pickup time, for example, that are connected to one another via a system bus. Information about an operation performed by the user on the display unit 542 is input to the CPU 531 via the operation-input interface 534 and control is performed based on the input-operation information.

The control section 530 displays the various cable-connection-guide information described with reference to FIGS. 2 to 11 on the display unit 542. Further, the control section 530 performs display-information switching and makes device settings, and so forth based on information input through the input unit 541.

The CPU 531 performs processing for the entire control section 530 and uses the RAM 533, as a work area. The ROM 532 stores a program configured to control the image-pickup section 510 and/or a program configured to perform storage control and reproduction control for an image signal and/or a sound signal, display the above-described cable-connection-guide information, and so forth.

Information input by the user through the input unit 541 is transmitted to the operation-input interface 534. The input information includes information input by the user, the information corresponding to display of the above-described cable-connection-guide information. The input information further includes information transmitted from each of various operation units provided in the image-pickup device, where the operation units include a zoom-adjustment key, an exposure-adjustment key, a shutter key, a video-shooting key, and so forth.

The display unit 542 connected to the display-control unit 535 includes a liquid-crystal display (LCD) or the like, and displays an image signal transmitted from the image-pickup section 510 and/or an image signal read from the storage medium 560 under the control of the control section 530, and the above-described cable-connection-guide information. Further, the display unit 542 can be set, as a user interface across which the user can input operation information.

The image-pickup device 500 shown in FIG. 17 is provided, as an example information-processing device according to an embodiment of the present invention. As described above, the present invention can be used not only for an image-pickup device but also a device to and/or from which data is input and/or output through the cable connection. The above-described example information-processing device may be any of devices configured to input and/or output data, the devices including a video and/or DVD-reproduction device, for example.

Thus, the present invention has been described in detail with reference to the above-described embodiments. However, it is obvious that the person skilled in the art can modify and replace the above-described embodiments with another embodiment without leaving the scope of claims of the present invention. That is to say, since the present invention has been disclosed, as an example, the present invention should not be construed in a limiting manner. Claims of the present invention should be considered to determine the scope of the present invention.

Further, the above-described series of processing steps described in this specification can be executed by hardware, software, or a combination of the above-described hardware and software. If the processing steps are executed by using the software, a program storing a processing sequence can be installed in a memory provided in a computer integrated into special-purpose hardware so that the program is executed. Otherwise, the program can be installed in a general-purpose computer that can execute various processing steps so that the program is executed.

For example, the above-described program can be stored in a hard disk and/or a ROM provided, as a storage medium, in advance. Otherwise, the program can be stored (recorded) in a removable-storage medium including a flexible disk, a compact-disk-read-only memory (CD-ROM), a magnet-optical (MO) disk, a digital-versatile disk (DVD), a magnetic disk, a semiconductor memory, and so forth temporarily and/or permanently. The above-described removable-storage medium can be presented, as so-called packaged software.

Further, the program can be transmitted from the above-described removable-storage medium and installed on a computer. Otherwise, the program can be transferred from a download site to the computer by air, or transferred to the computer by wire via a network including a local-area network (LAN), the Internet, and so forth. The computer can receive the program transferred in the above-described manner and install the transferred program onto a storage medium such as a hard disk provided in the computer.

Further, various processing steps written in this specification are not only executed in time sequence according to the written order but also executed in parallel and/or separately according to the processing capacity of a device executing the processing steps and/or necessity. Still further, in this specification, the word “system” denotes a logical set of at least two devices and the devices may not be provided in the same cabinet.

It should be understood by those skilled in the art that various modifications, combinations, sub-combinations and alterations may occur depending on design requirements and other factors insofar as they are within the scope of the appended claims or the equivalents thereof.

What is claimed is:

1. An information-processing device transferring data via at least one cable, the information-processing device comprising:
a display unit configured to perform information-display processing; and
a control unit configured to display guide information used for performing cable-connection processing on the display unit,
wherein when the guide information is displayed, the control unit displays terminal-image data on the display unit, the terminal-image data indicating a shape of each of a plurality of terminals to which the at least one cable is connected, and displays cable-image data on the display unit based on terminal-selection information input by a user, the cable-image data indicating the cable shape corresponding to a cable ready for a selected terminal.

2. The information-processing device according to claim 1, wherein the control unit displays external-device-terminal-image data on at least two external-device terminals that can be provided on an external device that is to be connected to the information-processing device by using the at least one cable on the display unit, and displays cable-image data on a cable ready for a selected external-device terminal based on information about the selected external-device terminal, the selected information being input by the user.

3. The information-processing device according to claim 1, wherein when the cable-image data is displayed, the control unit displays the cable-image data and the terminal-image data on the connection terminal corresponding to each of ends of the at least one cable in combination.

4. The information-processing device according to claim 1, wherein the control unit displays the terminal-image data on the plurality of terminals to which the at least one cable is connected and a description of processing performed by using the terminal corresponding to the displayed terminal-image data on the display unit.

5. The information-processing device according to claim 1, wherein the control unit displays reference information used for connecting the at least one cable on the display unit.

6. The information-processing device according to claim 1, wherein the control unit displays reference information used for connecting the at least one cable and information used for accepting shifting to a screen image showing setting processing performed in the information-processing device when the reference information includes a description of the setting processing on the display unit.

7. The information-processing device according to claim 1, wherein the control unit displays a confirmation-screen image of a type of a device to which the at least one cable is connected on the display unit, selects the guide information corresponding to a specified device based on information that is input by the user and that specifies the device type, and displays the selected guide information on the display unit.

8. The information-processing device according to claim 1, wherein when an image picked up by the information-processing device and/or an image stored in a storage unit is displayed on the display unit, the control unit superimposes the guide information on the displayed image, as a translucent image, so that the guide information is displayed.

9. An information-processing method used for displaying guide information used for establishing a cable connection in an information-processing device transferring data via at least one cable, the information-processing method comprising the steps of:
displaying terminal-image data indicating a shape of each of a plurality of terminals to which the at least one cable is connected on a display unit by a control unit;
detecting terminal-selection information by the control unit, the terminal-selection information being input by the user; and
displaying cable-image data indicating the cable shape corresponding to a cable ready for a terminal selected by the user by the control unit.

10. The information-processing method according to claim 9, wherein the terminal-image-data-display step is a step of displaying external-device-terminal-image data on a plurality of external-device terminals that can be provided on an external device that is to be connected to the information-processing device by using the at least one cable on the display unit,
wherein the terminal-selection-information-detection step is a step of detecting that the user inputs information about selection of an external-device terminal, and
wherein the cable-image-data-display step is a step of displaying the cable-image data on a cable ready for the external-device terminal selected by the user.

11. The information-processing method according to claim 9, wherein the cable-image-data-display step is a step of displaying the cable-image data and the terminal-image data on the connection terminal corresponding to each of ends of the at least one cable in combination when the cable-image data is displayed.

12. The information-processing method according to claim 9, wherein the terminal-image-data-display step is a step of displaying terminal-image data on the plurality of terminals to which the at least one cable is connected and a description of processing performed by using the terminal corresponding to the displayed terminal-image data on the display unit.

13. The information-processing method according to claim 9, further comprising the step of displaying reference information used for connecting the at least one cable on the display unit by using the control unit.

14. The information-processing method according to claim 13, wherein the reference-information-display step is a step of displaying reference information used for connecting the at least one cable and information used for accepting shifting to a screen image showing setting processing performed in the information-processing device when the reference information includes a description of the setting processing on the display unit.

15. The information-processing method according to claim 9, further comprising the step of displaying a confirmation-screen image of a type of a device to which the at least one cable is connected on the display unit, selecting the guide information corresponding to a specified device based on information that is input by the user and that specifies the device type, and displaying the selected guide information on the display unit by the control unit.

16. The information-processing method according to claim 9, further comprising the step of displaying the guide information when an image picked up by the information-processing device and/or an image stored in a storage unit is displayed on the display unit under the control of the control unit by superimposing the guide information on the displayed image, as a translucent image.

17. A computer program which makes an information-processing device display guide information used for establishing a cable connection, where the information-processing device transfers data via at least one cable, the computer program comprising the steps of:
displaying terminal-image data indicating a shape of each of a plurality of terminals to which the at least one cable is connected on a display unit by a control unit;
detecting terminal-selection information by the control unit, the terminal-selection information being input by the user; and
displaying cable-image data indicating the cable shape corresponding to a cable ready for a terminal selected by the user by the control unit.
